(19) United States
(12) Patent Application Publication
(10) Pub. No.: US 2026/0336619 A1
(43) Pub. Date: Oct. 29, 2026

(54) VEHICLE SPEED PLANNING METHOD, APPARATUS, ELECTRONIC DEVICE, AND STORAGE MEDIUM

(71) Applicant: Chongqing Changan Technology Co., Ltd., Chongqing (CN)

(72) Inventors: Wanhong LI, Chongqing (CN); Xiaolong LAN, Chongqing (CN); Yufang WEN, Chongqing (CN); Qian CHEN, Chongqing (CN); Huanqing ZHANG, Chongqing (CN)

(73) Assignee: Chongqing Changan Technology Co., Ltd., Chongqing (CN)

(21) Appl. No.: 19/707,395

(22) Filed: Jun. 15, 2026

Related U.S. Application Data
(63) Continuation of application No. PCT/CN2025/122948, filed on Sep. 22, 2025.

(30) Foreign Application Priority Data
Jan. 13, 2025 (CN) 202510050834.1

(51) Int. Cl. B60W 30/16; B60W 30/095

(52) U.S. Cl. CPC B60W 30/16; B60W 30/0953; B60W 30/0956; B60W 2554/802; B60W 2555/60

(57) ABSTRACT

Embodiments of the present disclosure provide a vehicle speed planning method, a vehicle speed planning apparatus, an electronic device, and a storage medium, including: determining a vehicle planning decision label corresponding to a target vehicle by means of collected surrounding information; determining a target ST reference line of the target vehicle corresponding to each of different vehicle planning decision labels; performing smoothing processing on the target ST reference line to generate a smoothed ST reference line; and differentiating the smoothed ST reference line to output a target speed planning curve. That is, a planning decision label of a target vehicle is determined by means of collected surrounding information, a target ST reference line is generated based on each of different labels, and then smoothing processing and a quadratic programming algorithm are used for optimization, an optimal speed and acceleration curves are finally outputted.

### CROSS-REFERENCE TO RELATED APPLICATIONS

This application is a continuation of International Application No. PCT/CN2025/122948, filed on Sep. 22, 2025, which claims the priority of the Chinese patent application with the application No. 202510050834.1, filed on Jan. 13, 2025, both of the applications are incorporated herein by reference in their entireties.

### TECHNICAL FIELD

The present disclosure relates to the field of intelligent driving technology, and in particular, to a vehicle speed planning method, a vehicle speed planning apparatus, an electronic device, and a storage medium.

### BACKGROUND

As one of the representatives of the new four modernizations of automobiles, intelligence is currently developing more and more rapidly, among which the autonomous driving technology of automobiles is the main battlefield for intelligent development. Autonomous driving technology can be divided into six modules according to the technical flow: perception, localization, prediction, decision-making, planning, and control, among which the planning module plays a key role in connecting the preceding and the following. Vehicles are divided into path planning and speed planning according to longitudinal and lateral movements, where the purpose of speed planning is to plan a smooth speed sequence for the vehicle that meets the vehicle control requirements. It complements path planning and plays a key role in the subsequent lateral and longitudinal control of the vehicle. The mutual support of the two technologies can greatly improve the intelligence level of the vehicle and accelerate the process of commercial implementation.

However, the speed planning in the related art is limited to a narrow-sense ST-graph-assisted speed planning, and cannot consider the complex road conditions in real vehicle intelligent driving scenarios, thus the planning of the vehicle speed is singular and cannot be applied to all scenarios.

### SUMMARY

An objective of the present disclosure is to provide a vehicle speed planning method to solve the problem in the prior art of how to control a motor to improve vehicle stability.

To achieve the above objective, the present disclosure discloses a vehicle speed planning method, the method including:
determining a vehicle planning decision label corresponding to a target vehicle by means of collected surrounding information;
determining a target ST reference line of the target vehicle corresponding to each of different said vehicle planning decision labels;
performing smoothing processing on the target ST reference line to generate a smooth ST reference line;
differentiating the smooth ST reference line to output a target speed planning curve.

In an implementation, the determining the vehicle planning decision label corresponding to the target vehicle by means of the collected surrounding information includes:
when a first vehicle exists ahead of the target vehicle in its driving lane and the target vehicle maintains a preset vehicle-following distance with a second vehicle, determining that the vehicle planning decision label corresponding to the target vehicle is a vehicle-following label;
when the preset vehicle-vehicle-following distance corresponding to the target vehicle is changed, determining that the vehicle planning decision label corresponding to the target vehicle is a distance-keeping label;
when a third vehicle, which changes lanes to cut into the driving lane of the target vehicle, exists within a preset range of the driving lane of the target vehicle, determining that the vehicle planning decision label corresponding to the target vehicle is a cut-in label.

In an implementation, the determining the target ST reference line of the target vehicle corresponding to each of the different said vehicle planning decision labels includes:
when the vehicle planning decision label is any one of the vehicle-following label, the distance-keeping label, and the cut-in label, acquiring a standard vehicle-following distance;
determining a target vehicle-following distance according to a pre-acquired first current scenario of the target vehicle and the standard vehicle-following distance, and constructing a vehicle-following distance line in a preset ST diagram for the target vehicle-following distance;
determining a second current scenario of the target vehicle according to the target vehicle-following distance, and constructing a transition reference line corresponding to the target vehicle in the preset ST diagram; and
constructing the target ST reference line in the preset ST diagram according to the vehicle-following distance line and the transition reference line.

In an implementation, the determining the target vehicle-following distance according to the pre-acquired first current scenario of the target vehicle and the standard vehicle-following distance, and constructing the vehicle-following distance line in the preset ST diagram for the target vehicle-following distance includes:
when the current scenario is that the target vehicle is in a lane-changing state, acquiring a time-to-collision between the target vehicle and a rear vehicle in a lane adjacent to the driving lane of the target vehicle, and determining a safety level of the rear vehicle according to the time-to-collision;
if the safety level of the rear vehicle is a dangerous state, calibrating a first offset coefficient according to a speed difference between the target vehicle and a front vehicle in the driving lane of the target vehicle;
if the safety level of the rear vehicle is a safe state, calibrating the first offset coefficient according to an invasion time gap class between the target vehicle and the front vehicle in the driving lane of the target vehicle;
when the current scenario is that the target vehicle is in an end-of-land-change transition state, preliminarily calibrating a transition state time according to an invasion time gap, acquiring a first time offset coefficient according to the speed difference, and a second time offset coefficient according to an invasion time gap class between the target vehicle and the rear vehicle, and acquiring a time gap coefficient increment;
generating the first offset coefficient based on the first time offset coefficient, the second time offset coefficient, and the time gap coefficient increment;
when the current scenario is that the target vehicle is in a non-lane-changing state, setting the first offset coefficient to a target value;
adjusting the standard vehicle-following distance according to the first offset coefficient to obtain the target vehicle-following distance; and
constructing the vehicle-following distance line in the preset ST diagram for the target vehicle-following distance.

In an implementation, the determining the safety level of the rear vehicle according to the time-to-collision includes:
when it is detected that the time-to-collision is less than a first preset value, determining that the safety level of the rear vehicle is the dangerous state;
when it is detected that the time-to-collision is a negative number or infinity, acquiring the invasion time gap class between the target vehicle and the rear vehicle, and when the invasion time gap class is less than a second preset value, determining that the safety level of the rear vehicle is the dangerous state.

In an implementation, the acquiring the invasion time gap class between the target vehicle and the rear vehicle includes:
generating the invasion time gap class according to a pre-calibrated target vehicle-following distance and a distance ratio between the target vehicle and the front vehicle or the rear vehicle.

In an implementation, the determining the second current scenario of the target vehicle according to the target vehicle-following distance, and constructing the transition reference line corresponding to the target vehicle in the preset ST diagram includes:
when the second current scenario is a long-distance non-invasion, setting a calibration lookup table and setting a speed offset coefficient lookup table according to a pre-acquired time-to-collision between the target vehicle and the front vehicle;
performing linear interpolation according to the time-to-collision to obtain a speed offset coefficient;
generating a reference speed of the target vehicle according to the speed offset coefficient, a current speed of the target vehicle, and a current speed of the front vehicle;
constructing a first transition reference line corresponding to the target vehicle in the preset ST diagram according to the reference speed;
when the second current scenario is a short-distance invasion, acquiring a safe acceleration;
acquiring an acceleration offset amount according to the safe acceleration;
generating a smooth acceleration according to the safe acceleration and the acceleration offset amount; and
constructing a second transition reference line corresponding to the target vehicle in the preset ST diagram according to the smooth acceleration.

In an implementation, the determining the vehicle planning decision label corresponding to the target vehicle by means of the collected surrounding information includes:
when the collected surrounding information is that an obstacle exists ahead of the target vehicle in the driving lane and lanes at both sides corresponding to the driving lane of the target vehicle are in an obstacle-free state, determining that the vehicle planning decision label corresponding to the target vehicle is a decelerate-to-pass label.

In an implementation, the decelerate-to-pass label includes a first decelerate-to-pass label, and the determining the target ST reference line of the target vehicle corresponding to each of the different said vehicle planning decision labels includes:
when the vehicle planning decision label is the first decelerate-to-pass label, acquiring a decelerate-to-pass time corresponding to the target vehicle;
acquiring a lower boundary distance resulting from mapping the decelerate-to-pass time onto a lower boundary of the preset ST diagram;
acquiring a ratio of the lower boundary distance to the decelerate-to-pass time to obtain a first constraint curve, where the first constraint curve includes a speed;
taking minimum values of the speed of the constraint curve and a pre-acquired speed limit of the driving lane of the target vehicle to obtain the target ST reference line corresponding to the target vehicle.

In an implementation, the decelerate-to-pass label includes a second decelerate-to-pass label, and the determining the target ST reference line of the target vehicle corresponding to each of the different vehicle planning decision labels includes:
when the vehicle planning decision label is the second decelerate-to-pass label, acquiring a decelerate-to-pass time corresponding to the target vehicle;
acquiring a lower boundary distance resulting from mapping the decelerate-to-pass time onto a lower boundary of a preset coordinate system;
acquiring a ratio of the lower boundary distance to the decelerate-to-pass time to obtain a first constraint curve, where the first constraint curve includes a speed;
taking minimum values of the speed of the constraint curve and a pre-acquired speed limit of the driving lane of the target vehicle to obtain a second constraint curve;
acquiring an intersection point of the vehicle-following distance line acquired in advance and the second constraint curve to obtain the target ST reference line corresponding to the target vehicle.

In an implementation, the determining the vehicle planning decision label corresponding to the target vehicle by means of the collected surrounding information includes:
when the collected surrounding information is that a merging vehicle exists within a preset range of the driving lane of the target vehicle, determining that the vehicle planning decision label corresponding to the target vehicle is a merging label, where the merging label includes a merging deceleration label and a merging acceleration label.

In an implementation, the determining the target ST reference line of the target vehicle corresponding to each of the different vehicle planning decision labels includes:
when the vehicle planning decision label is the merging deceleration label, acquiring a predicted speed of the merging vehicle;
searching a pre-acquired safety distance calibration table for a target safety distance between the target vehicle and the merging vehicle corresponding to the predicted speed;
taking maximum values of a speed corresponding to the target vehicle and a speed corresponding to the merging vehicle to obtain the target ST reference line corresponding to the target vehicle.

In an implementation, before the step of determining the vehicle planning decision label corresponding to the target vehicle by means of the collected surrounding information, the method includes:
drawing a rectangular box of a vehicle surrounding the target vehicle according to predicted trajectory information of the surrounding vehicle;
acquiring a set of projection distances between each pre-set point of the target vehicle and a pre-acquired planned path of the target vehicle;
taking a minimum value in the set of projection distances as a target projection distance;
if the target projection distance is less than a preset threshold, mapping the surrounding vehicle corresponding to the target projection distance to the ST diagram, where the ST diagram includes a mapping time and a mapping distance of the surrounding vehicle mapped to the ST diagram;
drawing an obstacle region in the ST diagram according to the time and the distance of the surrounding vehicle mapped to the ST diagram.

In an implementation, the determining the target ST reference line of the target vehicle corresponding to each of the different vehicle planning decision labels includes:
when the vehicle planning decision label is the merging acceleration label, determining, based on a mapping time in the preset ST diagram, whether the mapping time is a mapping time period;
if yes, the vehicle-following distance line acquired in advance, where the vehicle-following distance line acquired in advance is a vehicle-following distance line corresponding to the target ST reference line generated when the vehicle planning decision label is any one of the vehicle-following label, the distance-keeping label, and the cut-in label; if no, setting a calibration lookup table and setting a speed offset coefficient lookup table according to a pre-acquired time-to-collision between the target vehicle and the merging vehicle;
performing linear interpolation according to the time-to-collision to obtain a speed offset coefficient;
generating a reference speed of the target vehicle according to the speed offset coefficient, a current speed of the target vehicle, and a current speed of the merging vehicle;
generating a merging transition reference line according to the reference speed;
setting a constant speed line corresponding to the target vehicle for the reference speed; and
constructing the target ST reference line corresponding to the target vehicle according to the constant speed line and the merging transition reference line.

The present disclosure discloses a vehicle speed planning apparatus, the apparatus including:
a first determination module, configured to determine a vehicle planning decision label corresponding to a target vehicle by means of collected surrounding information;
a second determination module, configured to determine a target ST reference line of the target vehicle corresponding to each of different vehicle planning decision labels;
a smoothing processing module, configured to perform smoothing processing on the target ST reference line to generate a smooth ST reference line; and
an output module, configured to differentiate the smooth ST reference line to output a target speed planning curve.

An embodiment of the present disclosure further discloses an electronic device, including at least one processor and a memory communicatively connected to the at least one processor;
the memory is configured to store a computer program;
the processor is configured to, when executing the program stored in the memory, cause the method according to the embodiments of the present disclosure to be implemented.

An embodiment of the present disclosure further discloses a computer-readable storage medium, having a computer program stored thereon, which, when executed by one or more processors, causes the method according to the embodiments of the present disclosure to be implemented by the processor.

### Beneficial Effects of the Present Invention

In the embodiments of the present disclosure, a vehicle planning decision label corresponding to a target vehicle is determined by means of collected surrounding information; a target ST reference line of the target vehicle corresponding to each of different vehicle planning decision labels is determined; smoothing processing is performed on the target ST reference line to generate a smooth ST reference line; the smooth ST reference line is differentiated to output a target speed planning curve. That is, in the embodiments of the present application the longitudinal decisions of intelligent driving in different scenarios is abstracted and refined into multiple vehicle planning decision labels; different target ST reference lines based on different labels are generated, at this time the target ST reference line is a rough ST reference line; then smoothing processing is performed on the target ST reference line; an objective function related to the ST reference line is constructed by using a quadratic programming algorithm; a solver is called in combination with other constraint conditions; and a target speed planning curve that best meets the requirements is outputted, i.e., speed and acceleration curves can be outputted. That is, a planning decision label of a target vehicle is determined by collecting surrounding information; a target ST reference line is generated based on each of different labels; then smoothing processing and a quadratic programming algorithm are used for optimization; and optimal speed and acceleration curves are finally outputted. This method not only improves the decision accuracy and response speed of an intelligent driving system, but also enhances the stability and safety of the system, enabling a vehicle to perform speed control more intelligently and efficiently in different driving scenarios.

### BRIEF DESCRIPTION OF DRAWINGS

FIG. 1 is a step flow chart of a vehicle speed planning method provided in an embodiment of the present disclosure.

FIG. 2 is a schematic structural diagram of a vehicle speed planning apparatus provided in an embodiment of the present disclosure.

FIG. 3 is a schematic structural diagram of an electronic device provided in an embodiment of the present disclosure.

FIG. 4 is an exemplary block diagram of a software architecture for planning a longitudinal speed provided in an embodiment of the present disclosure.

FIG. 5 is a schematic diagram of an exemplary speed planning technical route based on an ST diagram reference line provided in an embodiment of the present disclosure.

FIG. 6 is a schematic diagram of an exemplary scenario of mapping a predicted trajectory into an ST diagram provided in an embodiment of the present disclosure.

FIG. 7 is a schematic diagram of an exemplary mapping of a predicted trajectory into an ST diagram provided in an embodiment of the present disclosure.

FIG. 8 is a schematic diagram of an exemplary generalized vehicle-following reference line and a planned ST curve provided in an embodiment of the present disclosure.

FIG. 9 is a schematic diagram of an exemplary short-distance invasion and a reasonable ST reference line curve provided in an embodiment of the present disclosure.

FIG. 10 is a schematic diagram of an exemplary smooth transition process during invasion provided in an embodiment of the present disclosure.

FIG. 11 is a schematic diagram of an exemplary typical scenario for a decelerate-to-pass label provided in an embodiment of the present disclosure.

FIG. 12 is a schematic diagram of an exemplary ST diagram for a decelerate-to-pass label in a simple scenario provided in an embodiment of the present disclosure.

FIG. 13 is a schematic diagram of an exemplary ST diagram for a decelerate-to-pass label in a complex scenario provided in an embodiment of the present disclosure.

FIG. 14 is a schematic diagram of an exemplary merging scenario provided in an embodiment of the present disclosure.

FIG. 15 is a schematic diagram of an exemplary ST diagram for a merging acceleration label provided in an embodiment of the present disclosure.

FIG. 16 is a schematic diagram of an exemplary ST diagram for merging deceleration provided in an embodiment of the present disclosure.

FIG. 17 is a schematic diagram of an exemplary curve outputted from a quadratic programming solver provided in an embodiment of the present disclosure.

### DESCRIPTION OF EMBODIMENTS

The embodiments of the present disclosure will be described below with reference to the accompanying drawings and preferred embodiments. Those skilled in the art can easily understand other advantages and effects of the present disclosure from the content disclosed in this specification. The present disclosure can also be implemented or applied through other different specific embodiments. Various details in this specification can also be modified or changed based on different viewpoints and applications without departing from the spirit of the present disclosure. It should be understood that the preferred embodiments are only for illustrating the present disclosure, not for limiting the scope of protection of the present disclosure.

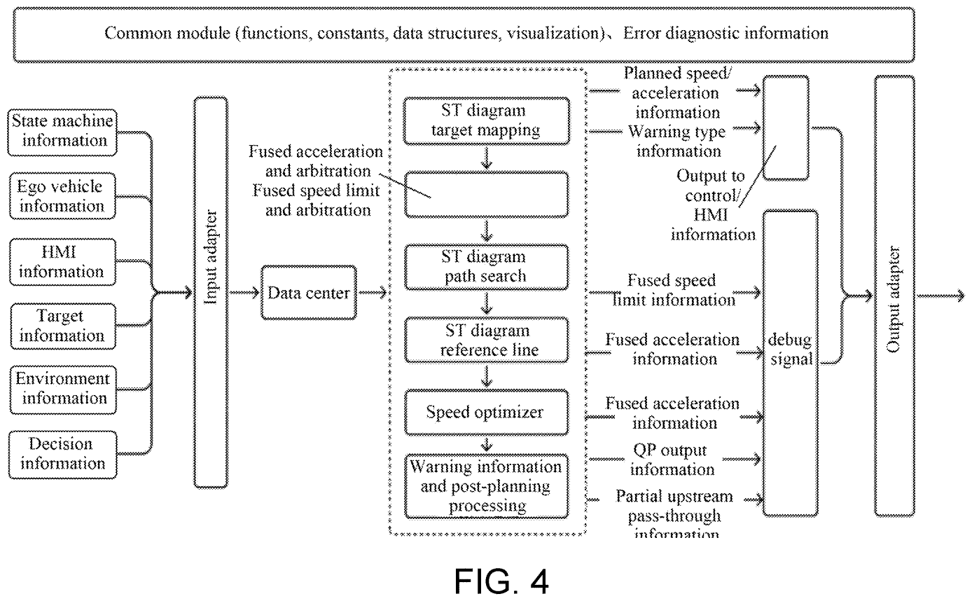

It should be noted that, in the embodiments of the present application, referring to FIG. 4, FIG. 4 is an exemplary overall software framework for speed planning, which mainly consists of four parts.

Part 1 is a common module of a software, including common functions, common constant parameters, common data structures, and visualization, as well as error diagnosis information, which facilitates outputting error information of each link for analysis.

Part 2 is an input adapter, including signal reception of state machine information, target vehicle information, target information, etc., and some logic conversions, where all input data constitutes a data center Data_center.

Part 3 is a core functional module of the speed planning software, including ST diagram target mapping; fusion of speed limit, acceleration and arbitration; ST diagram path search; ST diagram reference line; speed optimizer; and warning information and post-processing.

Part 4 is an output adapter, including output to longitudinal control, HMI, and output of some debug signals.

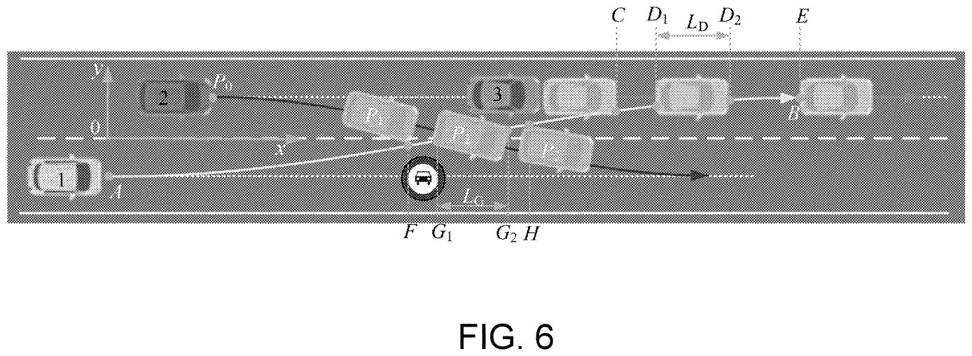

Referring to FIG. 6, FIG. 6 is a schematic diagram of mapping a target vehicle to an ST diagram. In the ST diagram, S coordinate is distance, and T is corresponding to each time instant. In FIG. 6, vehicle No. 3 and vehicle No. 2 are surrounding traffic vehicles. It should be noted that the subsequent descriptions of static traffic vehicles, front vehicles, rear vehicles, merging vehicles, and first vehicle, second vehicle, third vehicle refer to all vehicles other than a target vehicle that are traveling within a preset range of the same road section as the target vehicle, and are also vehicles that need to be considered for their influence on the speed planning of the target vehicle.

Returning to FIG. 6, the predicted trajectories corresponding to vehicles No. 2 and No. 3 are shown as curves. Vehicle No. 1 is a host vehicle, i.e., a target vehicle in the following description. A vehicle prohibition warning sign in front of vehicle No. 1 represents some static traffic vehicles, so a lane-changing path is planned for vehicle No. 1, as shown by a white curve in FIG. 6.

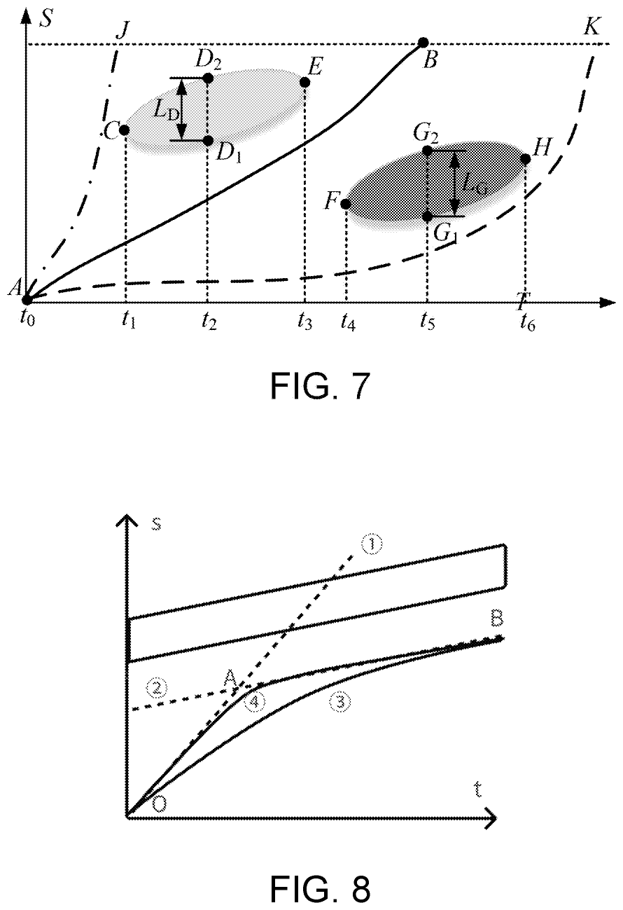

The influence of vehicle No. 2 and vehicle No. 3 on the white curve is analyzed. Combined with FIG. 6, it can be seen that when vehicle No. 2 in FIG. 6 reaches position P1, the projection point F of the right front of the vehicle just touches the white trajectory, and a trajectory length occupied on the white curve is 0; when vehicle No. 2 reaches position P2, the projection points of vehicle No. 2 on the white curve are G1 and G2, respectively, and a trajectory length occupied by G1 and G2 on the white curve is LG; as vehicle No. 2 continues to travel, when it reaches position P3, the projection point H of the left rear of the vehicle just leaves the white trajectory, and a trajectory length occupied on the white curve becomes 0 again. Therefore, this process can be expressed by a two-dimensional graph of “occupied trajectory length-time”, i.e., a preset ST diagram in the embodiments of the present application, as shown in FIG. 7. Therefore, in conjunction with FIG. 6 and FIG. 7, when vehicle No. 2 in FIG. 6 reaches position P1 at time t4, it is represented as a point F in the ST diagram of FIG. 7; when vehicle No. 2 reaches point P2 at time t5, it is represented as a line segment having a length LG in the ST diagram. Therefore, when time is discretized, the trajectory occupation process of vehicle No. 2 from position P1 to position P3, when mapped to the ST diagram, is a two-dimensional region. In summary, in FIG. 6, as long as any monotonically increasing, continuous, and differentiable white curve that bypasses the two traffic vehicle regions is planned, the safe lane change of vehicle No. 1, i.e., the target vehicle, can be ensured. The derivative of this white curve is a speed sequence curve. Therefore, it can be concluded that the purpose of the embodiments of the present application is how to search for an obstacle avoidance curve in the ST diagram, and then obtain speed and acceleration planning i.e., a speed planning process based on the obstacle avoidance curve.

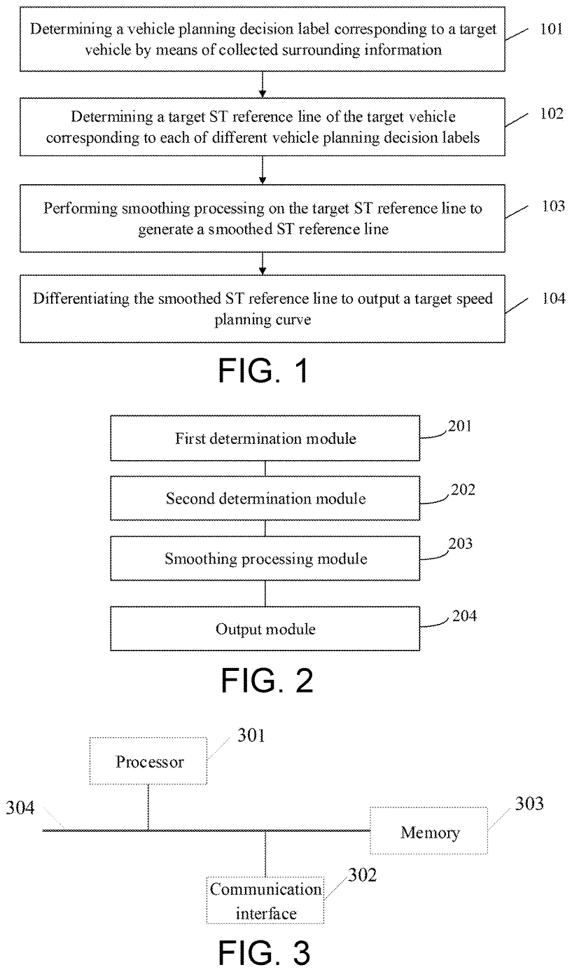

Referring to FIG. 1, a step flow chart of a method for processing a high-definition map provided in an embodiment of the present disclosure is shown, specifically including the vehicle-following steps.

In step 101, a vehicle planning decision label corresponding to a target vehicle by means of collected surrounding information is determined.

Further, before the step of determining the vehicle planning decision label corresponding to the target vehicle by means of the collected surrounding information, the method includes:
drawing a rectangular box of a vehicle surrounding the target vehicle according to predicted trajectory information of the surrounding vehicle;
acquiring a set of projection distances between each pre-set point of the target vehicle and a pre-acquired planned path of the target vehicle;
taking a minimum value in the set of projection distances as a target projection distance;
if the target projection distance is less than a preset threshold, mapping the surrounding vehicle corresponding to the target projection distance to an ST diagram, where the ST diagram includes a mapping time and a mapping distance of the surrounding vehicle mapped to the ST diagram;
drawing an obstacle region in the ST diagram according to the time and the distance of the surrounding vehicle mapped to the ST diagram.

It should be noted that, in the embodiments of the present application, before acquiring a vehicle planning decision label, a ST diagram in the embodiments of the present application has been pre-constructed.

Specifically, an exemplary representation of constructing a ST diagram can be found in FIG. 7. First, a longitudinal cumulative length of a planned path of a host vehicle is calculated, and a length index sequence number is matched thereto; 8-second predicted trajectory information of a surrounding vehicle is received at a time interval of 0.1 s, and a rectangular box of the surrounding vehicle is drawn for each trajectory point and heading angle of the surrounding vehicle; after a target vehicle is treated as a rectangle, the left rear, left body midpoint, left front, right front, right body midpoint, and right rear of the target vehicle are used as 6 judgment points, and projection distances from these points to the planned path of the host vehicle are calculated; the minimum value of the above 6 projected perpendicular distances is taken; if the minimum value is less than a preset judgment threshold, it indicates that the surrounding vehicle will invade into the planned path of the host vehicle at a future time, and the obstacle vehicle is mapped to the ST diagram; if mapping to the ST diagram is required, the minimum index minIndex and the maximum index maxIndex of the projection points of the 6 judgment points on the host vehicle path are selected, and the two indices correspond to two distances of the host vehicle's planned path, respectively; finally, an obstacle region of the ST diagram is drawn according to the time and distance mapped to the ST diagram.

It should be noted that, in the embodiments of the present application, a time range of a ST diagram can be defined as 0~8 s, with time discretization of 0.1 s, totaling 81 points.

After the ST diagram is constructed, a path search can be performed. Referring to FIG. 7, three speed curves, i.e., a dashed line, a solid line, and a dash-dot line, can be planned in three regions. The three regions can be regarded as three search solution spaces. Actual meanings corresponding to different solution spaces are different. For example, vehicle traveling along the dashed line means that the host vehicle overtakes vehicle No. 3; vehicle traveling along the dash-dot line means that the host vehicle avoids vehicle No. 2 while driving. Which path to take can be informed by an upstream decision-making module in the architecture of FIG. 6.

When a path is determined, an array structure can be used to store upper and lower boundary information of the path. The structure information includes index, time, upper boundary, lower boundary, etc., which are used for constraint conditions for subsequent generation of a ST reference line and for quadratic programming solving.

In step 102, a target ST reference line of the target vehicle corresponding to each of different said vehicle planning decision label is determined.

When a ST path is determined, position constraint conditions are determined. Within this path, a rough reference line, i.e., a target ST reference line, can be generated in advance according to certain rules. This reference line is an array containing time t and distance s. Subsequently, a smoothing algorithm is used to smooth this rough ST reference line according to a certain cost function and constraint conditions to generate a smooth ST curve that meets the requirements. By performing first-order and second-order differentiation on the ST curve, planned speed and acceleration curves can be obtained.

It should be noted that, in the above steps 101-102, it is based on vehicle planning decision labels to obtain target ST reference lines corresponding to different labels. Therefore, first, it is necessary to determine what vehicle planning decision label corresponding to the target vehicle in a current scenario is.

Among them, there are many types of vehicle planning decision labels, mainly including vehicle-following (FOLLOW), distance-keeping (KEEPDIS), decelerate-to-pass (SPEEDCUT), cut-in (CUTIN), merge acceleration (MERGEACCEL), merge deceleration (MERGEDECEL), etc. Longitudinal speed planning strategies corresponding to different vehicle planning decision label types are different.

Next, the detailed content of generating a target ST reference line according to each vehicle planning decision label type will be described.

First, the first type is vehicle-following label, distance-keeping label, and cut-in label.

In one embodiment, the above steps 101-102 may further include, i.e., step 101, the determining the vehicle planning decision label corresponding to the target vehicle by means of the collected surrounding information includes:
when a first vehicle exists ahead of the target vehicle in its driving lane and the target vehicle maintains a preset vehicle-following distance with a second vehicle, determining that the vehicle planning decision label corresponding to the target vehicle is a vehicle-following label;
when the preset vehicle-following distance corresponding to the target vehicle is changed, determining that the vehicle planning decision label corresponding to the target vehicle is a distance-keeping label; and
when a third vehicle, which changes lanes to cut into the driving lane of the target vehicle, exists within a preset range of the driving lane of the target vehicle, determining that the vehicle planning decision label corresponding to the target vehicle is a cut-in label.

It should be noted that, in the embodiments of the present application, for the vehicle-following label, for example, it is assumed that a dynamic traffic vehicle exists at 100 meters directly ahead, and its speed is set to 60 kph, a target vehicle is expected to reach a position of 18 meters if the decision label is vehicle-following, since a vehicle-following distance that is acceptable to most drivers is 18 m based on a large number of tests.

The distance-keeping label is applicable to certain scenarios where a standard vehicle-following distance needs to be increased or decreased, for example, a scenario in which a traffic vehicle is driving on a lane line for a long time but never cuts in. To ensure safety, a target vehicle will maintain a certain safe distance from the traffic vehicle, and this distance is generally less than a vehicle-following distance.

The cut-in label means that a traffic vehicle in an adjacent lane will change lanes to cut into a host lane, affecting the acceleration of a target vehicle. Since the core processing ideas of short-distance invasion and long-distance vehicle-following scenarios for the cut-in label, the distance-keeping label, and the vehicle-following label are basically similar, the processes of acquiring a target ST reference line are the same. The vehicle-following label is taken as an example, the vehicle-following label is the most common decision label, requiring to maintain a certain safe vehicle-following distance from a front vehicle.

Step 102 includes, i.e., the determining the target ST reference line of the target vehicle corresponding to each of different vehicle planning decision labels includes:
when the vehicle planning decision label is any one of the vehicle-following label, the distance-keeping label, and the cut-in label, acquiring a standard vehicle-following distance;
determining a target vehicle-following distance according to a pre-acquired first current scenario of the target vehicle and the standard vehicle-following distance, and constructing a vehicle-following distance line in a preset ST diagram for the target vehicle-following distance;
determining a second current scenario of the target vehicle according to the target vehicle-following distance, and constructing a transition reference line corresponding to the target vehicle in the preset ST diagram;
constructing the target ST reference line in the preset ST diagram according to the vehicle-following distance line and the transition reference line.

A safe vehicle-following distance when driving straight and following a vehicle in a single lane is obtained through a large number of testing and calibration, so it can be called a standard vehicle-following distance. When encountering other special scenarios such as lane changing, in order to balance safety and comfort, the standard vehicle-following distance may need to be reduced or increased, and reference line generation strategies for different scenarios are different.

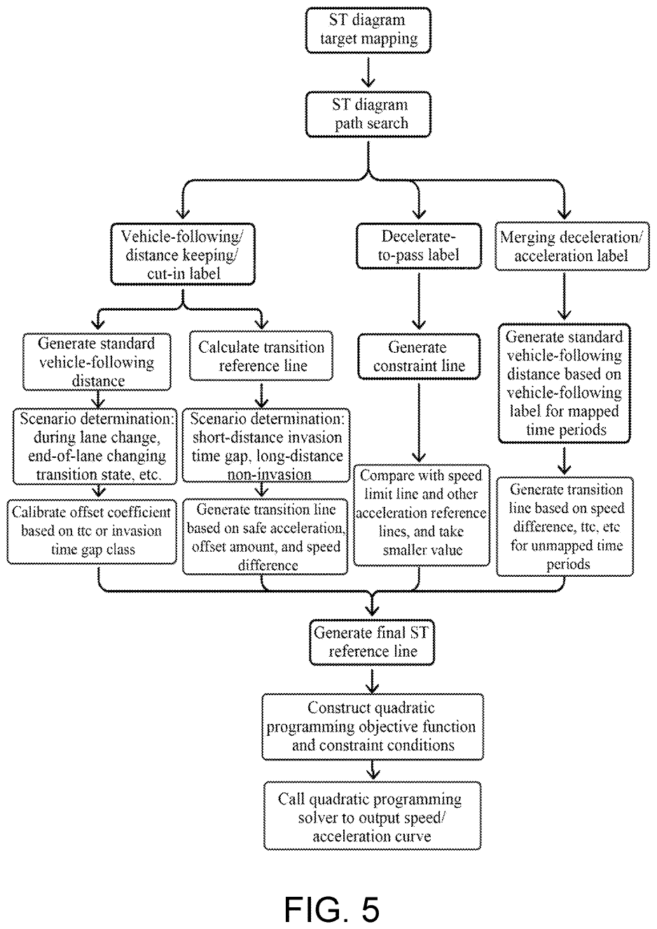

Therefore, referring to FIG. 5, first, a target vehicle-following distance is determined according to a pre-acquired first current scenario of a target vehicle and a standard vehicle-following distance. This target vehicle-following distance is a vehicle-following distance obtained after adjusting the standard vehicle-following distance based on an acquired offset coefficient.

Further, the determining the target vehicle-following distance according to the pre-acquired first current scenario of the target vehicle and the standard vehicle-following distance, and constructing the vehicle-following distance line in the preset ST diagram for the target vehicle-following distance includes:
when the current scenario is that the target vehicle is in a lane-changing state, acquiring a time-to-collision between the target vehicle and a rear vehicle in a lane adjacent to the driving lane of the target vehicle, and determining a safety level of the rear vehicle according to the time-to-collision;
if the safety level of the rear vehicle is a dangerous state, calibrating a first offset coefficient according to a speed difference between the target vehicle and a front vehicle in the driving lane of the target vehicle;
if the safety level of rear vehicle is a safe state, calibrating the first offset coefficient according to an invasion time gap class between the target vehicle and the front vehicle in the driving lane of the target vehicle;
when the current scenario is that the target vehicle is in an end-of-land-changing transition state, preliminarily calibrating a transition state time according to an invasion time gap, acquiring a first time offset coefficient according to the speed difference, and a second time offset coefficient according to an invasion time gap class between the target vehicle and the rear vehicle, and acquiring a time gap coefficient increment;
generating the first offset coefficient according to the first time offset coefficient, the second time offset coefficient, and the time gap coefficient increment;
when the current scenario is that the target vehicle is in a non-lane-changing state, setting the first offset coefficient to a target value;
adjusting the standard vehicle-following distance according to the first offset coefficient to obtain the target vehicle-following distance;
constructing the vehicle-following distance line in the preset ST diagram for the target vehicle-following distance.

Further, the determining the safety level of the rear vehicle according to the time-to-collision includes:
when it is detected that the time-to-collision is less than a first preset value, the safety level of the rear vehicle is the dangerous state;
when it is detected that the time-to-collision is a negative number or infinity, acquiring the invasion time gap class between the target vehicle and the rear vehicle, and when the invasion time gap class is less than a second preset value, determining that the safety level of the rear vehicle is the dangerous state.

Therefore, first, when a current scenario is that a target vehicle is in a lane-changing state, a relative position and a speed difference between the target vehicle and each vehicle in a target lane need to be considered. The specific steps are as follows.

First, a safety level of a rear vehicle in an adjacent lane is determined.

When the target vehicle changes lanes, in addition to considering a front vehicle in the target lane where the target vehicle is located, it is also necessary to consider a rear vehicle in the target lane. When the rear vehicle is relatively dangerous (close distance), the target vehicle needs to generate a sufficiently large acceleration in a short time to quickly complete the lane change so as to avoid being rear-ended by the rear vehicle.

The specific operation steps are as follows:

1) a time-to-collision between the rear vehicle in the target lane and the target vehicle is calculated; when the time-to-collision is less than 6, it can be considered that the target vehicle's initiation of a lane change will cause great pressure on the rear vehicle, and the rear vehicle may not brake sufficiently, causing a rear-end collision, so it is considered very dangerous.

2) if the speed of the target vehicle is very close to that of the rear vehicle, the calculated time-to-collision may be negative or infinite, making the judgment invalid. In this case, the judgment is made according to an invasion time gap class between the target vehicle and the rear vehicle (the time gap invasion calculation can refer to the previous description). When invade_class<0.2, it is also considered relatively dangerous.

Second, if the rear is dangerous, an offset coefficient is calibrated according to a speed difference between the target vehicle and the front vehicle in the target lane.

For example, a speed difference (obstacle vehicle speed-target vehicle speed) lookup table is set to be spd_err_kph_table={−20.0, −15.0, −10.0, −7.0, −5.0, −2.0, 0.0, 2.0, 5.0, 7.0, 10.0, 15.0}, and an offset coefficient table is set to be gap_coeff_table={1.0, 0.8, 0.6, 0.5, 0.4, 0.3, 0.2, 0.16, 0.1, 0.05, 0.03, 0.02}. The interpretation of the above calibration table is as follows: the larger the speed difference, the more dangerous it is. To ensure the safety of following vehicle, the offset coefficient should be closer to 1, such as a scenario where the target vehicle changes lanes at high speed to the front of a stationary vehicle in an adjacent lane; conversely, it indicates safety, and the offset coefficient should be closer to 0. For example, when there is a fast-approaching vehicle in an adjacent lane, and this vehicle just overtakes the target vehicle, the target vehicle can slowly accelerate behind it, the driver does not feel dangerous although the invaded time gap is relatively large at this time, because the vehicle's speed is much faster than that of the target vehicle. Therefore, the offset coefficient should be small enough at this time to prevent the situation where the target vehicle fails to accelerate following the vehicle or even brakes.

Second, if the rear is safe, the offset coefficient is calibrated according to a time gap between the target vehicle and the front vehicle in the target lane.

If the rear is safe, the target vehicle can control its speed more “leisurely”, as long as it ensures that the target vehicle does not hit the front vehicle, without worrying about the rear vehicle rear-ending the target vehicle. At this time, the calibration can be performed in combination with a relative distance between the target vehicle and the front vehicle in the target lane. For example, the invasion time gap class can be divided into four classes: invade_class<0.6, 0.6<=invade_class && invade_class<1.2, 1.2<=invade_class && invade_class<2.5, invade_class>2.5. For each class branch, recalibration of the gap_coeff_table in 4.1.2 is performed. In this way, this allows the parameter decoupling and calibration of whether the rear is dangerous or not, which is convenient for engineering application.

Second, when the current scenario is that the target vehicle is in an end-of-land-changing transition state, generally speaking, when the lateral position of the center point of the target vehicle is within a certain distance threshold of the centerline of the target lane, the lane change can be considered completed. At this time, in the longitudinal direction, a standard vehicle-following time gap to the front vehicle may also be invaded, so it is necessary to slowly open this vehicle-following distance with a safe and comfortable deceleration. The specific operation steps are as follows.

A transition state time transition_STATe_time is preliminarily calibrated according to an invasion time gap.

Generally, the more the invasion time gap, the longer the time to open the distance. Therefore, calibration can be performed according to a current invasion time gap class. For example, an invasion time gap classlookup table is defined as time_gap_invade_class table={0.1, 0.2, 0.3, 0.4, 0.5, 0.6, 0.7, 0.8, 0.9, 1.0}, and a transition state time lookup table is defined as transition_STATe_time_table={10.0, 9.0, 8.0, 7.0, 6.0, 5.0, 4.0, 3.0, 2.0, 0.01}. Explanation: if half of a time gap is currently invaded, the time, obtained by looking up the table, of slowly opening the distance is 6 s.

A time offset coefficient based on a speed difference (time_offset_coeff_spd_err) is calculated. In step 1) only the invasion time gap class is analyzed, and different speed differences also have a certain influence on the time of slowly opening the distance. Generally speaking, the smaller the target speed relative to the target vehicle, the shorter the time of opening the distance, and a larger deceleration is generated to quickly open the distance.

A time offset coefficient based on an invasion time gap class for the rear vehicle (time_offset_rr_obj_timegap_invade) is calculated. Generally speaking, when the lane change is completed, if there is a rear vehicle relatively close, and if the target vehicle decelerates too quickly at this time, it may cause the rear vehicle to be unable to brake in time, leading to a rear-end collision. Therefore, the target vehicle's time of slowly opening the distance is also affected by the danger level of the rear vehicle. Therefore, the invasion time gap class between the target vehicle and the rear vehicle can be calculated, a one-dimensional look-up table can be established, and then the time offset coefficient based on the invasion time gap class for the rear vehicle can be obtained through calibration.

The time gap coefficient increment for slowly opening the distance is calculated. During slowly opening the distance, the standard vehicle-following distance offset coefficient must gradually increase. Therefore, an increment calculation method for each cycle is shown in Formula 1:

delt_coeff=(1−time_gap_invade_class)/(transition_state_time*time_offset_coeff_spd_err*time_offset_rr_obj_timegap_invade)*delt_t (Formula 1),
where in the above Formula 1, time_gap_invade_class represents a current invasion time gap class between a target vehicle and a front vehicle, delt_t represents a software operating cycle, time_offset_rr_obj_timegap_invade is a time offset coefficient based on a time gap class, transition_STATe_time is a time parameter in a transition state time look-up table, and time_offset_coeff_spd_err is a time offset coefficient based on a speed difference.

A first offset coefficient for this cycle is calculated, Formula 2 is as follows:

gap_coeff=gap_coeff_last+delt_coeff (Formula 2)
where in the above Formula 2, gap_coeff is a first offset coefficient, and delt_coeff is a time gap coefficient increment.

Third, when no lane change is made and the vehicle is not in an end-of-land-changing transition state.

When no lane change is made and the vehicle is not in the end-of-land-changing transition state, it indicates that this is a single-lane cruise vehicle-following scene, which is the most common and ordinary scene, and is processed according to the first offset coefficient gap_coeff=1.

It should be noted that in the embodiments of the present application, when performing calculations of offset coefficients etc., two parameters are involved: the first is time-to-collision, and the second is invasion time gap class.

Specifically, the time-to-collision (TTC) refers to a collision time with a front vehicle, representing the degree of danger with the front vehicle; the smaller the value, the more dangerous it is. Calculating the time-to-collision in advance can provide a quantitative indicator basis for the degree of danger for subsequent calibration parameters. The calculation steps are as follows.

It is considered that the longer the 8 s predicted trajectory time, the lower the accuracy, it is first determined that a predicted trajectory interval with higher confidence is the first 2 s.

For future time i, the predicted trajectory has a predicted speed v_{fi} attached, and the speed prediction of the target vehicle follows a uniform acceleration formula, i.e., the following Formula 3 for calculation:

$${v}_{e g o} = {v}_{0} t + \frac{1}{2} {a}_{0} {t}^{2} . \qquad ( Formula 3 )$$

Each time-to-collision for each time point in the first 2 s is calculated, comparison is made and a smaller value is taken, in which calculation is made according to Formula 4:

$$t t c = min ( \frac{Δ {s}_{i}}{Δ {v}_{i}} ) , \qquad ( Formula 4 )$$

where in Formula 4, Δsᵢ and Δvᵢ respectively represent a relative distance and a relative speed (m/s) between a target vehicle and a front vehicle.

Further, the acquiring the invasion time gap class between the target vehicle and the rear vehicle includes:
generating the invasion time gap class according to a pre-calibrated target vehicle-following distance and a distance ratio between the target vehicle and the front vehicle or the rear vehicle on the lane.

It should be noted that in the embodiments of the present application, the invasion time gap class also represents the degree of danger with the front vehicle; the smaller the value, the more dangerous it is. Calculating the invasion time gap class in advance can also provide a quantitative indicator basis for the degree of danger for subsequent calibration parameters. The calculation steps are as follows.

A target vehicle-following distance is calibrated. Generally, a vehicle-following time gap class is set on a human-machine interface of an intelligent driving vehicle. Under the same steady vehicle-following speed, different time gap classes correspond to different vehicle-following distances. The most suitable vehicle-following distance can be obtained through extensive testing and calibration. For example, assuming a current gear is 1^{st} gear and a speed of the front vehicle is 60 km/h, a calibrated target steady vehicle-following distance is target_pos=18 m.

An invasion class is calculated. For example, assuming a distance from the front vehicle to the target vehicle is actual_pos=9 m, a calculation formula for invasion time gap class invade_class is shown in Formula 5 below.

$$invade\_class = \frac{actual\_pos}{target\_pos} = \frac{9}{18} = 0.5 , \qquad ( Formula 5 )$$

where in the above Formula 5, target_pos is a pre-calibrated target vehicle-following distance, actual_pos is an actual distance between a vehicle ahead of or behind a target vehicle and the target vehicle during driving, and invade_class is an invasion time gap class.

Further, the determining the second current scenario of the target vehicle according to the target vehicle-following distance, and constructing the transition reference line corresponding to the target vehicle in a preset ST diagram includes:
when the second current scenario is a long-distance non-invasion, setting a calibration look-up table and setting a speed offset coefficient look-up table according to a pre-acquired time-to-collision between the target vehicle and the front vehicle;
performing linear interpolation according to the time-to-collision to obtain a speed offset coefficient;
generating a reference speed of the target vehicle according to the speed offset coefficient, a current speed of the target vehicle, and a current speed of the front vehicle;
constructing a first transition reference line corresponding to the target vehicle in the preset ST diagram according to the reference speed;
when the second current scenario is a short-distance invasion, acquiring a safety acceleration;
acquiring an acceleration offset amount according to the safety acceleration;
generating a smooth acceleration according to the safety acceleration and the acceleration offset amount; and
constructing a second transition reference line corresponding to the target vehicle in the preset ST diagram according to the smooth acceleration.

It should be noted that in the embodiments of the present application, as can be seen from FIG. 8, when a target vehicle-following distance is relatively far, a curve OA needs to be generated for transition. If the starting point of the target vehicle-following distance happens to pass through point O, no transition curve is needed. Therefore, two situations: long-distance non-invasion and short-distance invasion are mainly involved.

The first is calculating a first transition reference line for long-distance non-invasion.

As can be seen from FIG. 8, when a target vehicle-following line at point 0 is greater than 0, it can be considered a long-distance non-invasion scenario. At this time, a target vehicle is still far from the target vehicle-following distance, and the main factor determining the degree of danger is not the distance factor, but a speed difference between the target vehicle and a front traffic vehicle. The general operation steps for this scenario are as follows.

A time-to-collision is calculated. If the time-to-collision is less than 100 and greater than 0, the scenario can be considered relatively dangerous and braking is required. At this time, according to time-to-collision, a calibration look-up table is set, collision_time_table={2,4,6,8,10,12,20,50,100}, and then a speed offset coefficient look-up table coeff_table={0,0.2,0.4,0.6,0.8,0.9,0.92,0.95,1.0} is set. According to the corresponding time-to-collision, a speed offset coefficient coeff is obtained by linear interpolation. Finally, according to the speed offset coefficient, a desired speed of the target vehicle is calculated:

target_spd=(v_{ego}−v_{obs})·coeff+v_{obs} (Formula 6),
where in the above formula 6, v_{ego} represents a speed of a target vehicle, v_{obs} represents a speed of a traffic vehicle, and coeff is a speed offset coefficient.

If the time-to-collision does not meet the above conditions, it can be considered that the front traffic vehicle is far away and its speed is also high. Therefore, dynamic calibration can be performed according to the speed difference. For example, a speed difference look-up table is set as: spd_kph_err_table={−2.0, 0.0, 2.0, 5.0, 8.0, 10.0, 15.0}, and a speed difference offset coefficient look-up table is set as: coeff_table={0.2, 0.3, 0.5, 0.6, 0.7, 0.9, 1.0}, and a desired speed of the target vehicle can be obtained by looking up the table.

After a reference speed is obtained, a curve 1 in FIG. 8, a first transition reference line, can be generated according to a constant speed calculation formula.

Second, a second transition reference line when invasion is calculated.

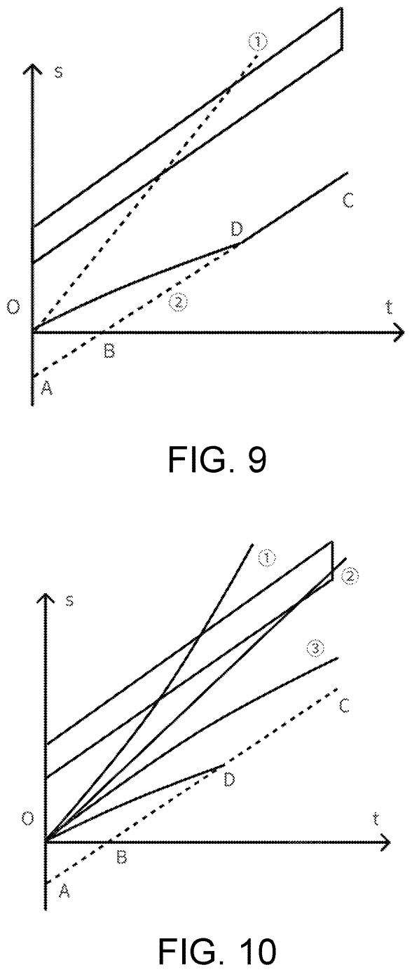

As shown in FIG. 9, a part of s is less than 0, indicating that when a traffic vehicle cuts in, a target vehicle has a certain invasion amount. Therefore, when this scenario is processed, two points need to be considered:
1) considering that a generalized vehicle-following reference line should not have a situation where s is less than 0 (the target vehicle cannot reverse at a reverse speed), a dashed line ABC is processed as a polyline OBC;
2) since the slope of an OB segment is 0, if qp is directly used to smooth this polyline segment, a particularly large deceleration will be generated. Therefore, for short-distance invasion, the polyline segment OBC needs to be smoothed in advance according to a certain acceleration.

Therefore, first, a safety acceleration safe_accel is calculated, which represents a theoretical safety acceleration value when the target vehicle interacts with the traffic vehicle. The specific operation steps are as follows.

First, a series of pending acceleration tables according to acc table={2, 1.5, 1, 0.5, 0, −0.5, −1, −1.5, −2} are generated.

Second, starting from an acceleration of 2, a uniform acceleration curve is generated and whether this curve intersects with a traffic vehicle mapping polygon is checked.

Third, if they intersect, a next acceleration of 1.5 is taken and the same operation as in the second step is performed. If they do not intersect, the maximum safe acceleration for the interaction between the target vehicle and the traffic vehicle is outputted. As shown in FIG. 10, it is assumed that curve 1 is obtained with an acceleration of 0.5, curve 2 is a constant speed line of a current speed of the target vehicle, and curve 3 is obtained with an acceleration of −0.5. From the above, it can be seen that the maximum safe acceleration for the interaction between the target vehicle and the traffic vehicle is −0.5.

Secondly, an acceleration offset amount offset_accel is calculated.

Considering the accuracy of predicted trajectories and the need for the driver to leave a certain psychological margin for the safety threshold, the above safe acceleration is only a perfect theoretical value and cannot represent various complex scenarios encountered in engineering applications. Therefore, a reasonable offset needs to be applied to the above safe acceleration to ensure a safe and comfortable transition. The specific operation steps for obtaining an offset acceleration are as follows.

First, if safe_accel>0.5, it indicates it is very safe. A typical scenario is as follows: a fast rear vehicle cuts in at a short distance, the target speed is high or the acceleration is large at this time, and the safe acceleration of the target vehicle is also correspondingly large. Two aspects are considered: if a calculated time-to-collision is less than 12, the calibration of the offset acceleration can be performed with reference to collision_time_table={4.0, 6.0, 8.0, 10.0, 12.0}, and offset_accel_table={−1.8, −1.6, −1.4, −1.2, −1}. If the above conditions are not met, calibration is performed according to the speed difference between the target vehicle and the traffic vehicle, with reference to spd_kph_err_table={−10.0, −8.0, −6.0, −4.0, −2.0, 0.0, 2.0, 4.0, 6.0, 8.0, 10.0, 15.0}; and offset_accel_table={−1.0, −0.9, −0.8, −0.6, −0.4, −0.3, −0.2, −0.2, 0.0, 0.0, 0.0, 0.0}.

Second, if a safe acceleration is greater than safe_accel>−0.5 and safe_accel<=0.5, this is a scenario that only requires slight deceleration. A typical scenario is as follows: a vehicle in an adjacent lane travels at approximately the same speed as a target vehicle and cuts in at a short distance, it may continuously invade the time gap for a relatively long period. At this time, safe_accel is likely to be calculated inaccurately and may jump between −0.5, 0.0, and 0.5, so these three acceleration segments need to be considered together. If a calculated time-to-collision is less than 12, the method refers to the corresponding step in the first case. If the above conditions are not met, further grading based on speed difference is considered: 1) if an absolute value of a speed difference is less than 4 km/h, the distance may not be able to be pulled apart for a long time, causing a sense of pressure, therefore, it is necessary to forcibly generate deceleration by increasing the acceleration offset; 2) Otherwise, an up-and-down fluctuation can be performed according to the speed difference calibration table in the first case, and calibration is refined through issues identified in real vehicle testing.

Third, if a safe acceleration is greater than safe_accel>−0.5, a typical scenario is as follows: cut-in is performed when a vehicle in an adjacent lane is much slower than a target vehicle. The processing scheme for this type of scenario is substantially similar to the first part. The main difference lies in various calibration parameters, which are not described in detail.

Next, smooth acceleration smooth_accel is obtained by adding a safe acceleration and an acceleration offset amount, i.e.:

smooth_accel=safe_accel+offset_accel (Formula 7),
where in the above Formula 7, smooth_accel is a smooth acceleration, safe_accel is a safety acceleration, and offset_accel is an acceleration offset amount.

It should be noted that, as shown in FIG. 10, after a smooth acceleration is obtained, a uniform acceleration line OD is generated, intersecting a line segment ABC at point D. Then a final generalized vehicle-following ST reference line is ODC.

In another embodiment, the above steps 101-102 may further include, i.e., step 101, the determining the vehicle planning decision label corresponding to the target vehicle by means of the collected surrounding information includes:
when the collected surrounding information is that an obstacle exists ahead of the target vehicle in the driving lane and lanes at both sides corresponding to the driving lane of the target vehicle are in an obstacle-free state, determining that the vehicle planning decision label corresponding to the target vehicle is a decelerate-to-pass label.

When a decision is made to issue a decelerate-to-pass label to a certain traffic vehicle, a decelerate-to-pass time is also issued simultaneously. The meaning of this time is: within this time, lane changing, obstacle avoidance, or offset may be initiated in the lateral direction, and in the longitudinal direction it only needs to ensure no collision with this traffic vehicle within this time.

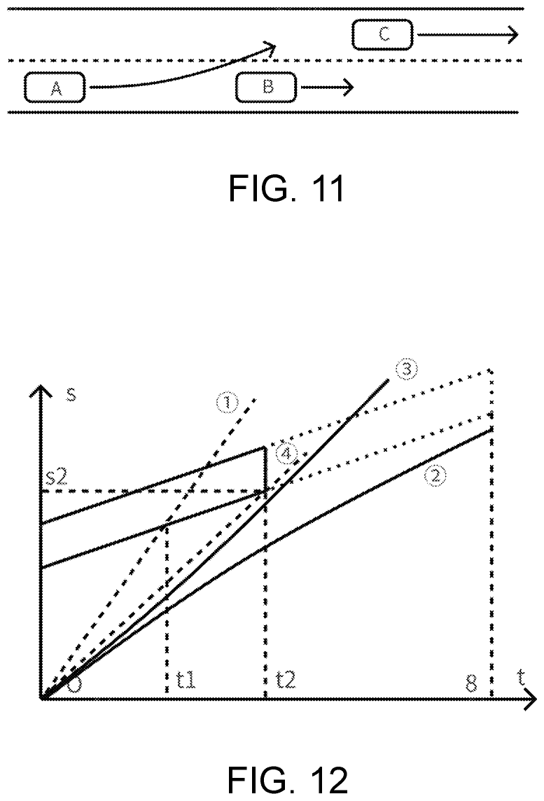

As shown in FIG. 11, A is set to be a host vehicle, there is a traffic vehicle B ahead in the host lane, and the target vehicle needs to change lanes to the left lane according to navigation, and there is a traffic vehicle C ahead in the left lane. When vehicle C is not considered first, the influence of different mapping methods of predicted trajectories of vehicle B on speed planning is discussed, as shown in FIG. 12.

(1) When a decision is made to give a vehicle-following label to vehicle B, its 8 s mapping region should be composed of a solid line mapping polygon on the left side and a dashed line mapping polygon on the right side in FIG. 12. A constant speed line of a current speed of the target vehicle is assumed as dashed line 1, it will intersect the mapping polygon at time t1, i.e., a collision occurs at time t1. Therefore, a ST curve planned according to the vehicle-following label is schematically shown as solid line 2. It can be seen that to avoid collision with a low-speed target, the slope of solid line 2 is smaller, meaning more deceleration is required.

(2) When a decision is made to give a decelerate-to-pass label having a time t2, a dashed polygon part after the time t2 can be removed, and then a “skimming” curve 3 is planned above the time t2. The target vehicle strictly following this curve can ensure no collision with a traffic vehicle within time t2.

From the three curves, it can be seen that only curve 3 allows the target vehicle to achieve a slight comfortable deceleration while changing lanes.

Further, step 102 may include that the decelerate-to-pass label includes a first decelerate-to-pass label, and the determining the target ST reference line of the target vehicle corresponding to each of different vehicle planning decision labels includes:
when the vehicle planning decision label is the first decelerate-to-pass label, acquiring a decelerate-to-pass time corresponding to the target vehicle;
acquiring a lower boundary distance resulting from mapping the decelerate-to-pass time onto a lower boundary of the preset ST diagram;
acquiring a ratio of the lower boundary distance to the decelerate-to-pass time to obtain a first constraint curve, where the first constraint curve includes a speed;
taking minimum values of the speed of the constraint curve and a pre-acquired speed limit of the driving lane of the target vehicle to obtain the target ST reference line corresponding to the target vehicle.

The first decelerate-to-pass label is a decelerate-to-pass label in a simple scenario.

Returning to FIG. 11, when vehicle C is not considered, and only vehicle B exists in the scenario, it is referred to as a decelerate-to-pass simple scenario. The steps for generating a ST reference line are as follows.

According to the decision's decelerate-to-pass time t2, a trajectory mapping part after t2 is removed.

A longitudinal distance corresponding to a mapped lower boundary at time t2 is s2, then a speed v_speedcut of a decelerate-to-pass constraint curve is defined as follows:

$$v\_speedcut = \frac{{s}_{2}}{{t}_{2}} , \qquad ( Formula 8 )$$

where in the above Formula 8, s2 is a longitudinal distance corresponding to a mapped lower boundary at time t2, and t2 is a decelerate-to-pass time.

When there are no other mapped obstacles in the ST diagram, the constraint curve's speed will be compared with a speed limit of the current road and a smaller value is taken. The curve after comparison is a generalized vehicle-following ST reference line.

Further, step 102 may further include that the decelerate-to-pass label includes a second decelerate-to-pass label, and the determining the target ST reference line of the target vehicle corresponding to each of different vehicle planning decision labels includes:
when the vehicle planning decision label is the second decelerate-to-pass label, acquiring a decelerate-to-pass time corresponding to the target vehicle;
acquiring a lower boundary distance resulting from mapping the decelerate-to-pass time onto a lower boundary of a preset coordinate system;
acquiring a ratio of the lower boundary distance to the decelerate-to-pass time to obtain a first constraint curve, where the first constraint curve including a speed;
taking minimum values of the speed of the constraint curve and a pre-acquired speed limit of the driving lane of the target vehicle to obtain a second constraint curve;
acquiring an intersection point of the vehicle-following distance line acquired in advance and the second constraint curve to obtain the target ST reference line corresponding to the target vehicle.

When vehicle C is considered and vehicle C serves as a vehicle-following target, since there are other mapped obstacles in the ST diagram, this can be referred to as a decelerate-to-pass complex scenario, corresponding to the second decelerate-to-pass label, and target ST reference line. The generation steps are as follows.

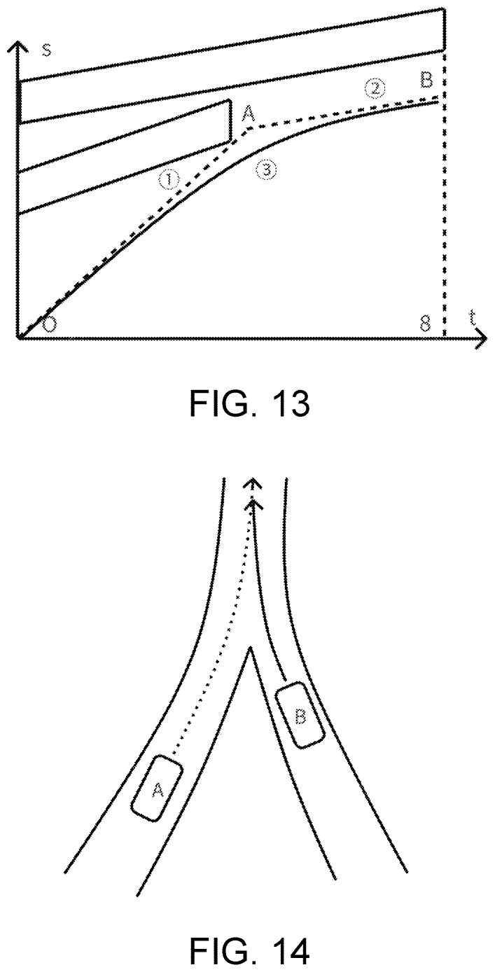

As shown in FIG. 13, a constraint curve according to a simple scenario is first generated, then it is compared with a speed limit line and a smaller value is taken to obtain a dashed line 1; a target vehicle-following line i.e. a dashed line 2 is generated according to a vehicle-following vehicle label; the dashed line 1 and dashed line 2 intersect at point A, then a polyline segment OAB is a generalized vehicle-following ST reference line.

In another embodiment, the above steps 101-102 may further include, i.e., step 101, the determining the vehicle planning decision label corresponding to the target vehicle by means of the collected surrounding information includes:
when the collected surrounding information is that a merging vehicle exists within a preset range of the driving lane of the target vehicle, determining that the vehicle planning decision label corresponding to the target vehicle is a merging label, where the merging label includes a merging deceleration label and a merging acceleration label.

FIG. 14 shows a typical merging scenario. A target vehicle is set to be vehicle A and a traffic vehicle is set to be vehicle B. A decision module will, based on a relative speed of the target vehicle and the traffic vehicle and a distance to a merging point, make a decision in advance to drive in front of vehicle B (overtaking) or behind vehicle B (yielding). At this time, the decision behavior of overtaking can be named as a merging acceleration label, and the decision behavior of yielding can be named as a merging deceleration label.

Further, step 102 may include, i.e., the determining the target ST reference line of the target vehicle corresponding to each of different vehicle planning decision labels includes:
when the vehicle planning decision label is the merging deceleration label, acquiring a predicted speed of the merging vehicle;
searching a pre-acquired safety distance calibration table for a target safety distance between the target vehicle and the merging vehicle corresponding to the predicted speed;
taking maximum values of a speed corresponding to the target vehicle and a speed corresponding to the merging vehicle to obtain the target ST reference line corresponding to the target vehicle.

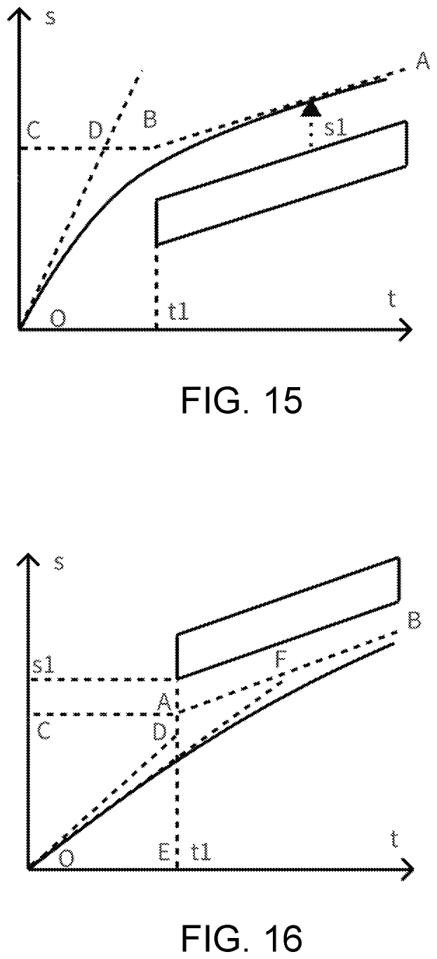

When a target vehicle overtakes other traffic vehicles in a merging scenario, it needs to maintain a sufficiently large safety distance from the traffic vehicle to avoid being rear-ended. As shown in FIG. 15, the specific steps for generating a ST reference line are as follows.

First, above a traffic vehicle mapping polygon, a safety distance s1 is obtained based on an empirical calibration table (e.g., 60 kph, a safe vehicle-following distance is approximately 18 m) according to a predicted speed of a traffic vehicle, representing a distance by which the target vehicle expects to maintain from the rear vehicle when the target vehicle reaches that position. Each distance point is connected to generate a dashed line segment AB.

Since a predicted trajectory of the traffic vehicle before time t1 does not intersect the target vehicle, it is not mapped to a ST diagram. Therefore, the endpoint A of a dashed line is temporarily extended leftwards to C.

Since the slope of a dashed line BC is 0, to ensure that a final generalized vehicle-following line fits a planned curve well, a guide line needs to be generated to connect BC. Here, considering taking larger values of the speeds of the target vehicle and the traffic vehicle, a constant speed line OD is generated, which then intersects BC at point D.

Finally, a polyline segment ABDO is a generalized vehicle-following ST reference line, and a planned ST curve is shown as a solid line in the figure.

Further, step 102 may also include, i.e., the determining the target ST reference line of the target vehicle corresponding to each of different vehicle planning decision labels includes:
when the vehicle planning decision label is the merging acceleration label, determining, based on a mapping time in the preset ST diagram, whether it is a mapping time period;
if yes, the vehicle-following distance line acquired in advance, where the vehicle-following distance line acquired in advance is a vehicle-following distance line corresponding to the target ST reference line generated when the vehicle planning decision label is any one of the vehicle-following label, the distance-keeping label, and the cut-in label; if no, setting a calibration lookup table and setting a speed offset coefficient lookup table according to a pre-acquired time-to-collision between the target vehicle and the merging vehicle;
performing linear interpolation according to the time-to-collision to obtain a speed offset coefficient;
generating a reference speed of the target vehicle according to the speed offset coefficient, a current speed of the target vehicle, and a current speed of the merging vehicle;
generating a merging transition reference line according to the reference speed;
setting a constant speed line corresponding to the target vehicle for the reference speed; and
constructing the target ST reference line corresponding to the target vehicle according to the constant speed line and the merging transition reference line.

When a target vehicle avoids other dynamic traffic vehicles in a merging scenario, safety and comfort should be fully and comprehensively considered. As shown in FIG. 13, the specific steps for generating a ST reference line are as follows.

A ST reference line for a mapping interval is generated. First, below a traffic vehicle mapping polygon, a standard vehicle-following line AB is obtained with reference to a vehicle-following label according to an empirical calibration table. If there is a closely following vehicle behind traffic vehicle B, it indicates that if the target vehicle yields to move behind vehicle B, this may cause a rear-end collision by the following vehicle, and thus a target vehicle-following line for following vehicle B should be adjusted and retracted according to a risk level of the following vehicle, i.e., an offset of the vehicle-following distance is performed. The risk level of the following vehicle can be determined with reference to the strategy of considering a rear target during lane change described above, and will not be repeated.

A time-to-collision is calculated, a time and a distance at which the traffic vehicle is firstly mapped to a ST diagram are set to be t1 and s1 respectively, and assuming that the target vehicle travels at a constant speed in the future, a time-to-collision at a future time t1 is calculated:

$$ttc = \frac{{s}_{1} - \overline{AE}}{{v}_{ego} - {v}_{obs , t 1}} + {t}_{1} , \qquad ( Formula 9 )$$

where in the above Formula 9, v_{ego} represents a speed of a target vehicle, v_{obs,tl} represents a predicted speed of a traffic vehicle at time t1, and A̅E̅ represents a length of a line segment A̅E̅. Note that when calculating a time-to-collision at a future time, the future time should be added to represent an estimated time-to-collision.

A constrained speed is calculated. If a time-to-collision is less than 12 and greater than 0, the scenario can be considered relatively dangerous and braking is required. A time-to-collision lookup table collision_time_table={2,4,6,8,10,12}, and a speed offset coefficient lookup table coeff_table={0,0.2,0.4,0.6,0.8,0.9} are set respectively. According to the corresponding time-to-collision, a speed offset coefficient coeff is obtained by linear interpolation. Finally, according to the speed offset coefficient, a desired speed of the target vehicle is calculated:

target_spd=(v_{ego}−v_{obs})·coeff+v_{obs} (Formula 10),
where in the above Formula 10, v_{ego} represents a speed of a target vehicle, and v_{obs} represents a speed of a traffic vehicle.

If a time-to-collision does not satisfy being less than 12 and greater than 0, it indicates that the speed of the traffic vehicle is greater than the speed of the target vehicle, a ST reference line can be directly generated using a standard vehicle-following time gap.

A constant speed line based on a current speed of the target vehicle intersects AE at D, and according to a desired speed target_spd, a constant speed ST line is generated and intersects AB at C (or intersects a line segment CD at a certain point), then a line segment OFB is a reference line that QP ultimately needs to smooth, and the smoothing effect is shown as the solid line in the figure.

In step 103, smoothing processing is performed on the target ST reference line to generate a smoothed ST reference line.

In step 104, the smoothed ST reference line is differentiated to output a target speed planning curve.

It should be noted that, in the embodiments of the present application, a smoothing algorithm is used to smooth this rough ST reference line according to a certain cost function and constraint conditions to generate a smooth ST curve that meets requirements. By performing first-order and second-order differentiation on the ST curve, a planned speed curve and an acceleration curve can be obtained.

Specifically, a quadratic programming algorithm is used to perform smoothing processing on the ST reference line.

A general expression of the quadratic programming algorithm is as follows:

$${min}_{x} J = \frac{1}{2} {x}^{T} H x + {f}^{T} x , \qquad ( Formula 11 )$$

$$s . t . \{ \begin{matrix}Ax \leq b \\ {A}_{eq} x = {b}_{eq} \\ lb \leq x \leq ub\end{matrix}$$

where in formula 11, f,x,b,b_{eq},lb,ub are vectors, and H,A,A_{eq} are matrices.

A quintic polynomial curve including 8 segments in total is selected. The quadratic programming algorithm needs to find a solution that satisfies the cost function under the minimum condition while meeting the constraint conditions, i.e., a total of 6×8 coefficients need to be solved. For a speed planning application scenario, the cost function can be quantitatively expressed from multiple mathematical models such as comfort and smoothness, and the above formula is transformed into:

$$( Formula 12 )$$

$$J = \frac{1}{2} {x}^{T} Hx + {f}^{T} x ⇒ {\sum }_{i = 1}^{8} [ {ω}_{1} t {\int }_{t = 0}^{1} {acc}_{i}^{2} ( t ) + {ω}_{2} {\int }_{t = 0}^{1} {jerk}_{i}^{2} ( t ) + … ] ,$$

where in formula 12, ωᵢ represents a weight of each cost function, and in the brackets the first term represents an acceleration cost function, and the second term represents a jerk cost function.

Focusing on a scenario of following a ST reference line, it is desired that the deviation between a planned smooth ST curve and the ST reference line should be as small as possible, so a relative position deviation is introduced on the basis of Formula 12,

$$( Formula 13 )$$

$$J = \frac{1}{2} {x}^{T} Hx + {f}^{T} x ⇒ {\sum }_{i = 1}^{8} [ {ω}_{1} {\int }_{t = 0}^{1} {acc}_{i}^{2} ( t ) + {ω}_{2} {\int }_{t = 0}^{1} {jerk}_{i}^{2} ( t ) + {ω}_{3} {\int }_{0}^{1} {( {s}_{i , 0} - {s}_{ref , i , 0} )}^{2} dt .$$

The third term, which is a cost function, is called a position deviation term, and its specific expression is as follows:

$$( Formula 14 )$$

$${ω}_{3} {\int }_{0}^{1} {( {s}_{i , 0} - {s}_{ref , i , 0} )}^{2} dt {ω}_{3} [ \begin{matrix}{a}_{i , 0} & {a}_{i , 1} & {a}_{i , 2} & {a}_{i , 3} & {a}_{i , 4} & {a}_{i , 5}\end{matrix} ] [ \begin{matrix}1 & t & {t}^{2} & {t}^{3} & {t}^{4} & {t}^{5} \\ t & {t}^{2} & {t}^{3} & {t}^{4} & {t}^{5} & {t}^{6} \\ {t}^{2} & {t}^{3} & {t}^{4} & {t}^{5} & {t}^{6} & {t}^{7} \\ {t}^{3} & {t}^{4} & {t}^{5} & {t}^{6} & {t}^{7} & {t}^{8} \\ {t}^{4} & {t}^{5} & {t}^{6} & {t}^{7} & {t}^{8} & {t}^{9} \\ {t}^{5} & {t}^{6} & {t}^{7} & {t}^{8} & {t}^{9} & {t}^{10}\end{matrix} ] [ \begin{matrix}{a}_{i , 0} \\ {a}_{i , 1} \\ {a}_{i , 2} \\ {a}_{i , 3} \\ {a}_{i , 4} \\ {a}_{i , 5}\end{matrix} ] - 2 {ω}_{3} {s}_{ref , i , 0} [ \begin{matrix}1 & \begin{matrix}t & {t}^{2} & {t}^{3} & {t}^{4} & {t}^{5}\end{matrix} ] [ \begin{matrix}{a}_{i , 0} \\ {a}_{i , 1} \\ {a}_{i , 2} \\ {a}_{i , 3} \\ {a}_{i , 4} \\ {a}_{i , 5}\end{matrix} ]\end{matrix} = {ω}_{3} {x}^{T} {H}_{3} x + {ω}_{3} {f}_{3}^{T} x .$$

When a current position of a host vehicle differs greatly from a target reference line position, the proportion of the position deviation term is large, so when the quadratic programming algorithm performs position sequence smoothing, it will be affected by the position deviation term, causing a planned curve to satisfy a reference line position as much as possible, thereby gradually approaching a target speed limit value in a gentle manner.

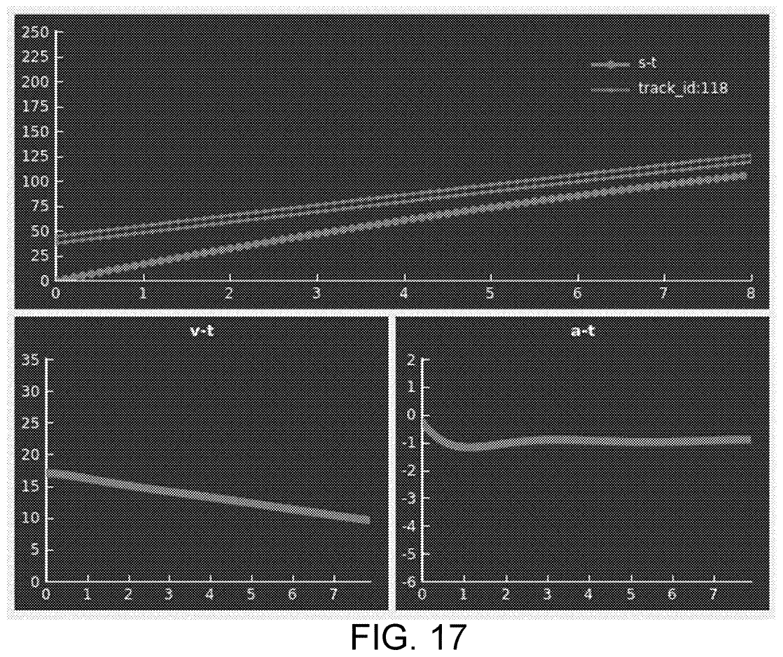

In addition, in the embodiments of the present application, referring to FIG. 17, taking a vehicle-following label as an example, a set of road test data is as follows. A traffic vehicle No. 118 exists at about 38 m ahead of a target vehicle lane, its speed is about 10 m/s, and its acceleration is about-0.1 m/ss. According to the method introduction of the long-distance non-invasion vehicle-following scenario above, a standard vehicle-following distance can be obtained through calibration to be about 15 m. Therefore, this scenario belongs to “long-distance non-invasion vehicle-following scenario”, so an offset coefficient and a transition curve can be further obtained by calibration in combination of information such as time-to-collision and speed difference, and a final ST reference line can be obtained.

A ST curve, VT curve, and AT curve output by a quadratic programming solver are shown in FIG. 17. It can be seen from the ST and VT curves that a target vehicle has been decelerating within a 8 s planning space, and when a target vehicle-following distance is reached, a planned vehicle speed is also substantially equal to that of a preceding vehicle, ensuring safety. On the other hand, it can be seen from the AT curve that a planned deceleration does not exceed −1.5, also ensuring comfort.

In the embodiments of the present disclosure, a vehicle planning decision label corresponding to a target vehicle is determined by means of collected surrounding information; a target ST reference line of the target vehicle corresponding to each of different vehicle planning decision labels is determined; smoothing processing is performed on the target ST reference line to generate a smoothed ST reference line; the smoothed ST reference line is differentiated to output a target speed planning curve. That is, in the embodiments of the present application, the longitudinal decision-making of intelligent driving in different scenarios is abstracted and refined into multiple vehicle planning decision labels; different target ST reference lines based on different labels are generated; at this time the target ST reference line is a rough ST reference line; then smoothing processing is performed on the target ST reference line; an objective function related to the ST reference line is constructed by using a quadratic programming algorithm; a solver is called in combination with other constraint conditions; and a target speed planning curve that best meets the requirements is outputted, i.e., speed and acceleration curves can be outputted. That is, a planning decision label of a target vehicle is determined by collecting surrounding information; a target ST reference line is generated based on each of different labels; then smoothing processing and a quadratic programming algorithm are used for optimization; and optimal speed and acceleration curves are finally outputted. This method not only improves the decision accuracy and response speed of an intelligent driving system, but also enhances the stability and safety of the system, enabling a vehicle to perform speed control more intelligently and efficiently in different driving scenarios.

Referring to FIG. 2, a vehicle speed planning apparatus provided by an embodiment of the present disclosure is shown, the apparatus including:
a first determination module 201, configured to determine a vehicle planning decision label corresponding to a target vehicle by means of collected surrounding information;
a second determination module 202, configured to determine a target ST reference line of the target vehicle corresponding to each of different vehicle planning decision labels;
a smoothing processing module 203, configured to perform smoothing processing on the target ST reference line to generate a smoothed ST reference line;
an output module 204, configured to differentiate the smoothed ST reference line to output a target speed planning curve.

In the embodiments of the present disclosure, a vehicle planning decision label corresponding to a target vehicle is determined by means of collected surrounding information; a target ST reference line of the target vehicle corresponding to each of different vehicle planning decision labels is determined; smoothing processing is performed on the target ST reference line to generate a smoothed ST reference line; the smoothed ST reference line is differentiated to output a target speed planning curve. That is, in the embodiments of the present application, a the longitudinal decision-making of intelligent driving in different scenarios is abstracted and refined into multiple vehicle planning decision labels; different target ST reference lines based on different labels are generated; at this time the target ST reference line is a rough ST reference line; then smoothing processing is performed on the target ST reference line; a quadratic programming algorithm is used to construct an objective function about the ST reference line; a solver is called in combination with other constraint conditions; and a target speed planning curve that best meets the requirements is outputted, i.e., speed and acceleration curves can be outputted. That is, a planning decision label of a target vehicle is determined by collecting surrounding information; a target ST reference line is generated based on each of different labels; then smoothing processing a quadratic programming algorithm are used for optimization; and optimal speed and acceleration curves are finally outputted. This method not only improves the decision accuracy and response speed of an intelligent driving system, but also enhances the stability and safety of the system, enabling a vehicle to perform speed control more intelligently and efficiently in different driving scenarios.

An embodiment of the present disclosure also provides an electronic device, as shown in FIG. 3, including a processor 301, a communication interface 302, a memory 303, and a bus 304.

The memory 303 is configured to store a computer program.

The processor 301 is configured to, when executing the program stored in the memory 303, cause the vehicle-following steps to be implement:
determining a vehicle planning decision label corresponding to a target vehicle by means of collected surrounding information;
determining a target ST reference line of the target vehicle corresponding to each of different vehicle planning decision labels;
performing smoothing processing on the target ST reference line to generate a smoothed ST reference line;
differentiating the smoothed ST reference line to output a target speed planning curve.

The bus mentioned in the above terminal may be a peripheral component interconnect (PCI) bus or an extended industry standard architecture (EISA) bus, etc. The bus can be divided into an address bus, a data bus, a control bus, etc. For ease of representation, only one thick line is used in the figure, but it does not mean that there is only one bus or one type of bus.

The memory may include a random access memory (RAM) or a non-volatile memory, such as at least one disk memory. In an implementation, the memory may also be at least one storage device located remotely from the aforementioned processor.

The above-mentioned processor may be a general-purpose processor, including a central processing unit (CPU), a network processor (NP), etc.; it may also be a digital signal processor (DSP), an application specific integrated circuit (ASIC), a field-programmable gate array (FPGA) or other programmable logic devices, discrete gate or transistor logic devices, or discrete hardware components.

The present disclosure also provides a storage medium, when instructions in the storage medium are executed by a processor of an electronic device, the electronic device is enabled to execute the vehicle speed planning method of the foregoing embodiments.

For the device embodiment, since it is basically similar to the method embodiment, the description is relatively simple, and the relevant parts can be referred to the partial description of the method embodiment.

The algorithms and displays provided herein are not inherently related to any particular computer, virtual device, or other equipment. According to the above description, the structure required to construct such a device is obvious. In addition, the present disclosure is not directed to any particular programming language. It should be understood that the content of the present disclosure described herein can be implemented using various programming languages, and the above description of specific languages is intended to disclose the best implementation of the present disclosure.

In the description provided herein, numerous specific details are set forth. However, it is understood that embodiments of the disclosure may be practiced without these specific details. In some instances, well-known methods, structures, and techniques have not been shown in detail in order not to obscure the understanding of this description.

Similarly, it should be understood that in the above description of exemplary embodiments of the disclosure, various features of the disclosure are sometimes grouped together in a single embodiment, figure, or description thereof for the purpose of streamlining the present disclosure and aiding in the understanding of one or more of the various inventive aspects. However, this method of disclosure should not be interpreted as reflecting an intention that the claimed disclosure requires more features than those expressly recited in each claim. Rather, as the following claims reflect, inventive aspects lie in less than all features of a single foregoing disclosed embodiment. Therefore, the claims following the detailed implementations are hereby expressly incorporated into implementations, with each claim standing on its own as a separate embodiment of this disclosure.

Those skilled in the art can understand that the modules in the device of the embodiment can be adaptively changed and placed in one or more devices different from the embodiment. The modules or units or components in the embodiment can be combined into one module or unit or component, and furthermore they can be divided into multiple sub-modules or sub-units or sub-components. Except where at least some of such features and/or processes or units are mutually exclusive, any combination of all features disclosed in this specification (including the accompanying claims, abstract, and drawings) and all processes or units of any method or device so disclosed may be used. Unless expressly stated otherwise, each feature disclosed in this specification (including the accompanying claims, abstract, and drawings) may be replaced by alternative features serving the same, equivalent, or similar purpose.

The various component embodiments of the disclosure may be implemented in hardware, or in software modules running on one or more processors, or in a combination thereof. Those skilled in the art will understand that a microprocessor or digital signal processor (DSP) may be used in practice to implement some or all of the functions of some or all of the components in a sorting device according to the disclosure. The disclosure may also be implemented as a device or apparatus program for performing part or all of the methods described herein. Such a program implementing the disclosure may be stored on a computer-readable medium, or may have the form of one or more signals. Such signals may be downloaded from an Internet website, or provided on a carrier signal, or provided in any other form.

It should be noted that the above-mentioned embodiments illustrate rather than limit the disclosure, and those skilled in the art can design alternative embodiments without departing from the scope of the appended claims. In the claims, any reference signs placed between parentheses shall not be construed as limiting the claims. The word “including” does not exclude the presence of elements or steps not listed in a claim. The word “a” or “an” preceding an element does not exclude the presence of a plurality of such elements. The disclosure may be implemented by means of hardware including several distinct elements, and by means of a suitably programmed computer. In a unit claim enumerating several means, several of these means may be embodied by one and the same hardware item. The use of the words first, second, and third, etc. does not denote any order. These words may be interpreted as names.

Those skilled in the art can clearly understand that, for the convenience and brevity of description, the specific working processes of the above-described devices, apparatuses, and units can be referred to the corresponding processes in the foregoing method embodiments, and will not be repeated here.

The above descriptions are only preferred embodiments of the present disclosure and are not intended to limit the present disclosure. Any modifications, equivalent substitutions, improvements, etc. made within the spirit and principle of the present disclosure shall be included in the protection scope of the present disclosure.

The above are only specific implementations of the present disclosure, but the protection scope of the present disclosure is not limited thereto. Any person skilled in the art can easily think of changes or substitutions within the technical scope disclosed by the present disclosure, which shall be covered within the protection scope of the present disclosure. Therefore, the protection scope of the present disclosure shall be subject to the protection scope of the claims.

It should be noted that the processes related to acquiring various data in the embodiments of the present application are all performed in compliance with the relevant data protection regulations and policies of the country where they are located, and with the authorization given by the owner of the corresponding devices.

What is claimed is:

1. A vehicle speed planning method, comprising:
determining a vehicle planning decision label corresponding to a target vehicle by means of collected surrounding information;
determining a target ST reference line of the target vehicle corresponding to each of different vehicle planning decision labels;
performing smoothing processing on the target ST reference line to generate a smoothed ST reference line; and
differentiating the smoothed ST reference line to output a target speed planning curve.

2. The method according to claim 1, wherein the determining the vehicle planning decision label corresponding to the target vehicle by means of the collected surrounding information comprises:
when a first vehicle exists ahead of the target vehicle in its driving lane and the target vehicle maintains a preset vehicle-following distance with a second vehicle, determining that the vehicle planning decision label corresponding to the target vehicle is a vehicle-following label;
when the preset vehicle-following distance corresponding to the target vehicle is changed, determining that the vehicle planning decision label corresponding to the target vehicle is a distance-keeping label; and
when a third vehicle, which changes lanes to cut into the driving lane of the target vehicle, exists within a preset range of the driving lane of the target vehicle, determining that the vehicle planning decision label corresponding to the target vehicle is a cut-in label.

3. The method according to claim 2, wherein the determining the target ST reference line of the target vehicle corresponding to each of the different vehicle planning decision labels comprises:
when the vehicle planning decision label is any one of the vehicle-following label, the distance-keeping label, and the cut-in label, acquiring a standard vehicle-following distance;
determining a target vehicle-following distance according to a pre-acquired first current scenario of the target vehicle and the standard vehicle-following distance, and constructing a vehicle-following distance line in a preset ST diagram for the target vehicle-following distance;
determining a second current scenario of the target vehicle according to the target vehicle-following distance, and constructing a transition reference line corresponding to the target vehicle in the preset ST diagram; and
constructing the target ST reference line in the preset ST diagram according to the vehicle-following distance line and the transition reference line.

4. The method according to claim 3, wherein the determining the target vehicle-following distance according to the pre-acquired first current scenario of the target vehicle and the standard vehicle-following distance, and constructing the vehicle-following distance line in the preset ST diagram for the target vehicle-following distance comprises:
when the current scenario is that the target vehicle is in a lane-changing state, acquiring a time-to-collision between the target vehicle and a rear vehicle in a lane adjacent to the driving lane of the target vehicle, and determining a safety level of the rear vehicle according to the time-to-collision;
if the safety level of the rear vehicle is a dangerous state, calibrating a first offset coefficient according to a speed difference between the target vehicle and a front vehicle in the driving lane of the target vehicle;
if the safety level of the rear vehicle is a safe state, calibrating the first offset coefficient according to an invasion time gap class between the target vehicle and the front vehicle in the driving lane of the target vehicle;
when the current scenario is that the target vehicle is in an end-of-land-changing transition state, preliminarily calibrating a transition state time according to an invasion time gap, acquiring a first time offset coefficient according to the speed difference, and a second time offset coefficient according to an invasion time gap class between the target vehicle and the rear vehicle, and acquiring a time gap coefficient increment;
generating the first offset coefficient according to the first time offset coefficient, the second time offset coefficient, and the time gap coefficient increment;
when the current scenario is that the target vehicle is in a non-lane-changing state, setting the first offset coefficient to a target value;
adjusting the standard vehicle-following distance according to the first offset coefficient to obtain the target vehicle-following distance; and
constructing the vehicle-following distance line in the preset ST diagram for the target vehicle-following distance.

5. The method according to claim 4, wherein the determining the safety level of the rear vehicle according to the time-to-collision comprises:
when it is detected that the time-to-collision is less than a first preset value, determining that the safety level of the rear vehicle is the dangerous state; and
when it is detected that the time-to-collision is a negative number or infinity, acquiring the invasion time gap class between the target vehicle and the rear vehicle, and when the invasion time gap class is less than a second preset value, determining that the safety level of the rear vehicle is the dangerous state.

6. The method according to claim 5, wherein the acquiring the invasion time gap class between the target vehicle and the rear vehicle comprises:
generating the invasion time gap class according to a pre-calibrated target vehicle-following distance and a distance ratio between the target vehicle and the front vehicle or the rear vehicle.

7. The method according to claim 3, wherein the determining the second current scenario of the target vehicle according to the target vehicle-following distance, and constructing the transition reference line corresponding to the target vehicle in the preset ST diagram comprises:
when the second current scenario is a long-distance non-invasion, setting a calibration look-up table and setting a speed offset coefficient look-up table according to a pre-acquired time-to-collision between the target vehicle and the front vehicle;
performing linear interpolation according to the time-to-collision to obtain a speed offset coefficient;
generating a reference speed of the target vehicle according to the speed offset coefficient, a current speed of the target vehicle, and a current speed of the front vehicle;
constructing a first transition reference line corresponding to the target vehicle in the preset ST diagram according to the reference speed;
when the second current scenario is a short-distance invasion, acquiring a safety acceleration;
acquiring an acceleration offset amount according to the safety acceleration;
generating a smooth acceleration according to the safety acceleration and the acceleration offset amount; and
constructing a second transition reference line corresponding to the target vehicle in the preset ST diagram according to the smooth acceleration.

8. The method according to claim 1, wherein the determining the vehicle planning decision label corresponding to the target vehicle by means of the collected surrounding information comprises:
when the collected surrounding information is that an obstacle exists ahead of the target vehicle in the driving lane and lanes at both sides corresponding to the driving lane of the target vehicle are in an obstacle-free state, determining that the vehicle planning decision label corresponding to the target vehicle is a decelerate-to-pass label.

9. The method according to claim 8, wherein the decelerate-to-pass label comprises a first decelerate-to-pass label, and the determining the target ST reference line of the target vehicle corresponding to each of the different vehicle planning decision labels comprises:
when the vehicle planning decision label is the first decelerate-to-pass label, acquiring a decelerate-to-pass time corresponding to the target vehicle;
acquiring a lower boundary distance resulting from mapping the decelerate-to-pass time onto a lower boundary of the preset ST diagram;
acquiring a ratio of the lower boundary distance to the decelerate-to-pass time to obtain a first constraint curve, wherein the first constraint curve comprises a speed; and
taking minimum values of the speed of the constraint curve and a pre-acquired speed limit of the driving lane of the target vehicle to obtain the target ST reference line corresponding to the target vehicle.

10. The method according to claim 8, wherein the decelerate-to-pass label comprises a second decelerate-to-pass label, and the determining the target ST reference line of the target vehicle corresponding to each of the different vehicle planning decision labels comprises:
when the vehicle planning decision label is the second decelerate-to-pass label, acquiring a decelerate-to-pass time corresponding to the target vehicle;
acquiring a lower boundary distance resulting from mapping the decelerate-to-pass time onto a lower boundary of a preset coordinate system;
acquiring a ratio of the lower boundary distance to the decelerate-to-pass time to obtain a first constraint curve, wherein the first constraint curve comprises a speed;
taking minimum values of the speed of the constraint curve and a pre-acquired speed limit of the driving lane of the target vehicle to obtain a second constraint curve; and
acquiring an intersection point of the vehicle-following distance line acquired in advance and the second constraint curve to obtain the target ST reference line corresponding to the target vehicle.

11. The method according to claim 1, wherein the determining the vehicle planning decision label corresponding to the target vehicle by means of the collected surrounding information comprises:
when the collected surrounding information is that a merging vehicle exists within a preset range of the driving lane of the target vehicle, determining that the vehicle planning decision label corresponding to the target vehicle is a merging label, wherein the merging label comprises a merging deceleration label and a merging acceleration label.

12. The method according to claim 11, wherein the determining the target ST reference line of the target vehicle corresponding to each of the different vehicle planning decision labels comprises:
when the vehicle planning decision label is the merging deceleration label, acquiring a predicted speed of the merging vehicle;
searching a pre-acquired safety distance calibration table for a target safety distance between the target vehicle and the merging vehicle corresponding to the predicted speed; and
taking maximum values of a speed corresponding to the target vehicle and a speed corresponding to the merging vehicle to obtain the target ST reference line corresponding to the target vehicle.

13. The method according to claim 11, wherein the determining the target ST reference line of the target vehicle corresponding to each of the different vehicle planning decision labels comprises:
when the vehicle planning decision label is the merging acceleration label, determining, based on a mapping time in the preset ST diagram, whether the mapping time is a mapping time period;
if yes, the vehicle-following distance line acquired in advance, wherein the vehicle-following distance line acquired in advance is a vehicle-following distance line corresponding to the target ST reference line generated when the vehicle planning decision label is any one of the vehicle-following label, the distance-keeping label, and the cut-in label; if no, setting a calibration look-up table and setting a speed offset coefficient look-up table according to a pre-acquired time-to-collision between the target vehicle and the merging vehicle;
performing linear interpolation according to the time-to-collision to obtain a speed offset coefficient;
generating a reference speed of the target vehicle according to the speed offset coefficient, a current speed of the target vehicle, and a current speed of the merging vehicle;
generating a merging transition reference line according to the reference speed;
setting a constant speed line corresponding to the target vehicle for the reference speed; and
constructing the target ST reference line corresponding to the target vehicle according to the constant speed line and the merging transition reference line.

14. The method according to claim 1, wherein before the step of the determining the vehicle planning decision label corresponding to the target vehicle by means of collected surrounding information, the method comprises:
drawing a rectangular box of a vehicle surrounding the target vehicle according to predicted trajectory information of the surrounding vehicle;
acquiring a set of projection distances between each pre-set point of the target vehicle and a pre-acquired planned path of the target vehicle;
taking a minimum value in the set of projection distances as a target projection distance;
if the target projection distance is less than a preset threshold, mapping the surrounding vehicle corresponding to the target projection distance to the ST diagram, wherein the ST diagram comprises a mapping time and a mapping distance of the surrounding vehicle mapped to the ST diagram; and
drawing an obstacle region in the ST diagram according to the time and the distance of the surrounding vehicle mapped to the ST diagram.

15. A vehicle speed planning apparatus, comprising:
at least one processor; and
a memory communicatively connected to the at least one processor;
wherein the memory stores a computer program executable by the at least one processor, and the computer program, when executed by the at least one processor, causes the at least one processor to:
determine a vehicle planning decision label corresponding to a target vehicle by means of collected surrounding information;
determine a target ST reference line of the target vehicle corresponding to each of different vehicle planning decision labels;
perform smoothing processing on the target ST reference line to generate a smoothed ST reference line; and
differentiate the smoothed ST reference line to output a target speed planning curve.

16. The apparatus according to claim 15, wherein when determining the vehicle planning decision label corresponding to the target vehicle by means of the collected surrounding information, the at least one processor is specifically configured to:
when a first vehicle exists ahead of the target vehicle in its driving lane and the target vehicle maintains a preset vehicle-following distance with a second vehicle, determine that the vehicle planning decision label corresponding to the target vehicle is a vehicle-following label;
when the preset vehicle-following distance corresponding to the target vehicle is changed, determine that the vehicle planning decision label corresponding to the target vehicle is a distance-keeping label; and
when a third vehicle, which changes lanes to cut into the driving lane of the target vehicle, exists within a preset range of the driving lane of the target vehicle, determine that the vehicle planning decision label corresponding to the target vehicle is a cut-in label.

17. The apparatus according to claim 16, wherein when determining the target ST reference line of the target vehicle corresponding to each of the different vehicle planning decision labels, the at least one processor is specifically configured to:
when the vehicle planning decision label is any one of the vehicle-following label, the distance-keeping label, and the cut-in label, acquire a standard vehicle-following distance;
determine a target vehicle-following distance according to a pre-acquired first current scenario of the target vehicle and the standard vehicle-following distance, and construct a vehicle-following distance line in a preset ST diagram for the target vehicle-following distance;
determine a second current scenario of the target vehicle according to the target vehicle-following distance, and construct a transition reference line corresponding to the target vehicle in the preset ST diagram; and
construct the target ST reference line in the preset ST diagram according to the vehicle-following distance line and the transition reference line.

18. The apparatus according to claim 17, wherein when determining the target vehicle-following distance according to the pre-acquired first current scenario of the target vehicle and the standard vehicle-following distance, and constructing the vehicle-following distance line in the preset ST diagram for the target vehicle-following distance, the at least one processor is specifically configured to:
when the current scenario is that the target vehicle is in a lane-changing state, acquire a time-to-collision between the target vehicle and a rear vehicle in a lane adjacent to the driving lane of the target vehicle, and determine a safety level of the rear vehicle according to the time-to-collision;
if the safety level of the rear vehicle is a dangerous state, calibrate a first offset coefficient according to a speed difference between the target vehicle and a front vehicle in the driving lane of the target vehicle;
if the safety level of the rear vehicle is a safe state, calibrate the first offset coefficient according to an invasion time gap class between the target vehicle and the front vehicle in the driving lane of the target vehicle;
when the current scenario is that the target vehicle is in an end-of-land-changing transition state, preliminarily calibrate a transition state time according to an invasion time gap, acquire a first time offset coefficient according to the speed difference, and a second time offset coefficient according to an invasion time gap class between the target vehicle and the rear vehicle, and acquire a time gap coefficient increment;
generate the first offset coefficient according to the first time offset coefficient, the second time offset coefficient, and the time gap coefficient increment;
when the current scenario is that the target vehicle is in a non-lane-changing state, set the first offset coefficient to a target value;
adjust the standard vehicle-following distance according to the first offset coefficient to obtain the target vehicle-following distance; and
construct the vehicle-following distance line in the preset ST diagram for the target vehicle-following distance.

19. The apparatus according to claim 18, wherein when determining the safety level of the rear vehicle according to the time-to-collision, the at least one processor is specifically configured to:
when it is detected that the time-to-collision is less than a first preset value, determine that the safety level of the rear vehicle is the dangerous state; and
when it is detected that the time-to-collision is a negative number or infinity, acquire the invasion time gap class between the target vehicle and the rear vehicle, and when the invasion time gap class is less than a second preset value, determine that the safety level of the rear vehicle is the dangerous state.

20. A non-transitory computer-readable storage medium, storing a computer program, wherein the computer program, when executed by a processor, causes the following steps to be implemented:
determining a vehicle planning decision label corresponding to a target vehicle by means of collected surrounding information;
determining a target ST reference line of the target vehicle corresponding to each of different vehicle planning decision labels;
performing smoothing processing on the target ST reference line to generate a smoothed ST reference line; and
differentiating the smoothed ST reference line to output a target speed planning curve.
